(19) United States
(12) Patent Application Publication
(10) Pub. No.: US 2014/0043810 A1
(43) Pub. Date: Feb. 13, 2014

(54) LIGHTING APPARATUS

(71) Applicant: SAMSUNG ELECTRONICS CO.,LTD., Suwon-si (KR)

(72) Inventors: Sok Hyun JO, Incheon (KR); Sang Ho YOON, Yongin-si (KR); Wook Pyo LEE, Seoul (KR); Hyung Jin KIM, Seoul (KR)

(73) Assignee: SAMSUNG ELECTRONICS CO.,LTD., Suwon-si (KR)

(21) Appl. No.: 13/964,368

(22) Filed: Aug. 12, 2013

(30) Foreign Application Priority Data
Aug. 10, 2012 (KR) 10-2012-0087933
Jun. 26, 2013 (KR) 10-2013-0073701

(51) Int. Cl. F21V 29/02; F21V 5/04; F21V 15/01; F21V 29/00; F21V 13/04

(52) U.S. Cl. CPC F21V 29/025; F21V 29/2206; F21V 13/04; F21V 15/011; F21V 5/04
USPC 362/235; 362/373; 362/294; 362/249.01

(57) ABSTRACT

A lighting apparatus including a base with a coupling rim and a supporting plate and a housing coupled to the coupling rim such that the supporting plate is covered. The housing includes a channel part to guide air in and an air introduction hole to introduce the guided air into an inner space of the housing. A cooling fan is included and is disposed on an upper surface of the supporting plate covered by the housing, wherein the cooling fan draws air introduced through the air introduction hole into the inner space of the housing, and discharges the in-drawn air outside through an air discharging hole in the base. A light source module is included and mounted on a lower surface of the supporting plate, wherein the channel part provides a region depressed in a stepped manner along an outer surface of the housing.

### CROSS-REFERENCE TO RELATED APPLICATIONS

This application claims the priority from Korean Patent Application No. 10-2012-0087933 filed in the Korean Intellectual Property Office on Aug. 10, 2012, and Korean Patent Application No. 10-2013-0073701 filed on Jun. 26, 2013, in the Korean Intellectual Property Office, the disclosures of which are incorporated herein by reference in there entireties.

### BACKGROUND

1. Field

Apparatuses and methods consistent with exemplary embodiments relate to a lighting apparatus, more particularly, to a lighting apparatus including a base, a housing, a cooling fan, and a lighting source.

2. Description of the Related Art

A lighting apparatus using a light emitting diode (LED) as a light source may transfer heat generated from the light source through a substrate to a heat sink and emit the heat into the surrounding atmosphere. Such a heat transfer to the surrounding atmosphere through natural convection exhibits a significantly low efficiency and, thus, a significantly large heat sink is mounted thereon to cool the light source. As a method of improving such a limitation, various methods have been considered, such as a method of increasing contact between a light source and a substrate to enhance thermal conduction, a method of forming a substrate with a metallic material to enhance thermal conduction, and the like.

### SUMMARY

An aspect of an exemplary embodiment provides a lighting apparatus, that may be capable of increasing a lifespan of a light source and improving light output by overcoming limited heat radiation efficiency according to natural convection by significantly increasing heat radiation efficiency.

Another aspect of an exemplary embodiment provides a lighting apparatus having a size that falls within the American National Standards Institute (ANSI) standard range and enhanced heat radiation with respect to a high output.

Another aspect of an exemplary embodiment provides a lighting apparatus having a size that falls within the range set by the American National Standards Institute (ANSI) and enhanced heat radiation with respect to a high output thereof.

According to an aspect of an exemplary embodiment, there is provided a lighting apparatus including: a base including a coupling rim and a supporting plate on an inner side of the coupling rim; a housing configured to be coupled to the coupling rim such that the supporting plate is covered, the housing comprising a channel part that is configured to guide an introduction of air and an air introduction hole that is configured to introduce the air guided through the channel part into an inner space of the housing; a cooling fan on an upper surface of the supporting plate covered by the housing, wherein the cooling fan is configured to draw air introduced through the air introduction hole into the inner space of the housing, and discharge the in-drawn air outside through an air discharging hole in the base; and a light source module mounted on a lower surface of the supporting plate, wherein the channel part provides a region depressed in a stepped manner along an outer surface of the housing.

The air introduction hole may have a ring shape along a circumference of the housing within the region depressed in the stepped manner of the channel part, and wherein the channel part may be upwardly extended along an outer side of the housing from a lower end of the housing to communicate with the air introduction hole.

The air introduction hole may have a ring shape along a circumference of the housing, and the channel part may include a first channel along the circumference of the housing in a position corresponding to the air introduction hole to communicate with the air introduction hole, and a second channel extended from the first channel to the lower end of the housing to be exposed to the outside.

The channel part may include a plurality of channels, and at least one of the plurality of channels may be recessed in the outer surface of the housing to communicate with the air introduction hole.

The coupling rim may include a groove having a shape and a position corresponding to the channel part such that the coupling rim can connect with the channel part of the housing.

The coupling rim may include a flange part protruding outwardly from a lower end thereof, and the flange part may have a plurality of vents formed in a circumference of the coupling rim.

The base may include an air discharging hole between an outer circumferential surface of the supporting plate and an inner surface of the coupling rim to radially discharge the air introduced into the inner space of the housing.

The base may include an air discharging hole in a central portion of the supporting plate to discharge the air introduced into the inner space of the housing.

The base may include a plurality of heat radiation fins on the upper surface of the supporting plate facing the cooling fan.

According to another aspect of an exemplary embodiment, there is provided a light source module including: a base having an air discharging hole; a housing including a channel part provided by depressed region in a stepped manner along an outer surface of the housing, and an air introduction hole configured to introduce air guided through the channel part into an inner space of the housing, wherein the housing is configured to be disposed on an upper side of the base, a cooling fan configured to be disposed within the housing, and configured to draw air into the inner space of the housing, and discharge the in-drawn air outwardly through the air discharging hole; and a light source module, configured to be disposed on a lower side of the base, and including at least one light emitting device and at least one lens disposed on the light emitting device.

The at least one lens may have a first surface facing the at least one light emitting device and a second surface opposing the first surface, the at least one lens may include a central incident surface configured such that light from the at least one light emitting device is incident on the central incident surface, and a reflective portion configured to protrude toward the at least one light emitting device along the circumference of the central incident surface, wherein the reflective portion is symmetrical based on a central optical axis, wherein the central incident surface and the reflective portion are provided in the first surface, and wherein a refractive portion is provided in the second surface and is configured to, protrude in a direction opposite the at least one light emitting device, and is configured to be symmetrical based on the optical axis.

The reflective portion may include a first reflective portion and a second reflective portion having different rotational radii with respect to the optical axis and are concentric, wherein the first reflective portion and the second reflective portion may have different sizes.

The first reflective portion and the second reflective portion may each have a side incident surface to which light from the at least one light emitting device is made incident and a reflective surface reflecting the incident light to the second surface.

The refractive portion may be configured to be disposed immediately above the at least one light emitting device, and may have a first refractive portion having a curved surface of which the optical axis is an apex and a second refractive portion forming a plurality of concentric circles with respect to the optical axis and having a convexo-concave structure formed along the circumference of the first refractive portion.

The reflective portion may be configured to be disposed outwardly of the refractive portion with regard to the optical axis such that the reflective portion surrounds the refractive portion.

### BRIEF DESCRIPTION OF THE DRAWINGS

The above and other aspects, features and other advantages will be more clearly understood from the following detailed description taken in conjunction with the accompanying drawings, in which:

FIG. 1 is an exploded perspective view schematically illustrating a lighting apparatus according to an exemplary embodiment;

FIG. 2 is a cross-sectional view schematically illustrating the lighting apparatus according to an exemplary embodiment;

FIG. 3 is a perspective view schematically illustrating a base in the lighting apparatus of FIG. 1;

FIG. 4 is a perspective view schematically illustrating a state in which a cooling fan is disposed on the base of FIG. 3;

FIG. 5 is a perspective view schematically illustrating a state in which a backflow prevention part is disposed on the cooling fan of FIG. 4;

FIG. 6 is a cross-sectional view schematically illustrating a state in which the lighting apparatus according to an exemplary embodiment is mounted on a ceiling;

FIG. 7 is a perspective view of FIG. 6;

FIG. 8 is an exploded perspective view schematically illustrating a lighting apparatus according to another exemplary embodiment;

FIG. 9 is a cross-sectional view schematically illustrating the lighting apparatus according to another exemplary embodiment;

FIG. 10 is a perspective view schematically illustrating a base in the lighting apparatus of FIG. 8;

FIG. 11 is a perspective view schematically illustrating a state in which a cooling fan is disposed on the base of FIG. 10;

FIG. 12 is a perspective view schematically illustrating a state in which a backflow prevention part is disposed on the cooling fan of FIG. 11;

FIG. 13 is a cross-sectional view schematically illustrating a state in which the lighting apparatus according to another exemplary embodiment is mounted on a ceiling;

FIG. 14 is a perspective view of FIG. 13;

FIG. 15 is an exploded perspective view schematically illustrating a lighting apparatus according to another exemplary embodiment;

FIG. 16 is a cross-sectional view schematically illustrating the lighting apparatus according to another exemplary embodiment;

FIG. 17 is a cross-sectional view schematically illustrating a state in which the lighting apparatus according to another exemplary embodiment is mounted on a ceiling;

FIG. 18 is a perspective view schematically illustrating a light source module of the lighting apparatus of FIG. 15;

FIG. 19 is a perspective view schematically illustrating a lens unit of the light source module of FIG. 18;

FIGS. 20A and 20B are cutaway perspective views schematically illustrating a lens of the lens unit of FIG. 19;

FIG. 21 is a cross-sectional view schematically illustrating an optical path within the light source module of FIG. 18;

FIG. 22 is a graph illustrating a light distribution curve of a lens;

FIGS. 23A through 23C are cross-sectional views schematically illustrating processes of fabricating a lens unit having lenses using a mold;

FIGS. 24A and 24B are cross-sectional views schematically illustrating a condensing lens having a general structure and a slim lens according to one or more exemplary embodiments;

FIG. 25 is a cross-sectional view schematically illustrating an exemplary embodiment of a substrate that may be employed in the lighting device;

FIG. 26 is a cross-sectional view schematically illustrating another embodiment of the substrate;

FIG. 27 is a cross-sectional view schematically illustrating a substrate according to a modification of FIG. 26;

FIGS. 28 through 31 are cross-sectional views schematically illustrating various exemplary embodiments of the substrate;

FIG. 32 is a cross-sectional view schematically illustrating an example of a light emitting device (LED chip) that may be employed in a lighting device according to various exemplary embodiments;

FIG. 33 is a cross-sectional view schematically illustrating another example of the light emitting device (LED chip) of FIG. 32;

FIG. 34 is a cross-sectional view schematically illustrating another example of the light emitting device (LED chip) of FIG. 32;

FIG. 35 is a cross-sectional view illustrating an example of an LED chip mounted on a mounting substrate, as a light emitting device (LED chip) that may be employed in a lighting device according to various exemplary embodiments;

FIG. 36 is an International Commission on Illumination (CIE) 1931 chromaticity diagram;

FIG. 37 is a block diagram schematically illustrating a lighting system according to an exemplary embodiment;

FIG. 38 is a block diagram schematically illustrating a detailed configuration of a lighting unit of the lighting system illustrated in FIG. 37 according to an exemplary embodiment;

FIG. 39 is a flow chart illustrating a method for controlling the lighting system illustrated in FIG. 37 according to an exemplary embodiment;

FIG. 40 is a view schematically illustrating the use of the lighting system illustrated in FIG. 37 according to an exemplary embodiment;

FIG. 41 is a block diagram of a lighting system according to another exemplary embodiment;

FIG. 42 is a view illustrating a format of a ZigBee signal according to an exemplary embodiment.

FIG. 43 is a view illustrating a sensing signal analyzing unit and an operation control unit according to an exemplary embodiment;

FIG. 44 is a flow chart illustrating an operation of a wireless lighting system according to an exemplary embodiment;

FIG. 45 is a block diagram schematically illustrating constituent elements of a lighting system according to another exemplary embodiment;

FIG. 46 is a flow chart illustrating a method for controlling a lighting system according to an exemplary embodiment;

FIG. 47 is a flow chart illustrating a method for controlling a lighting system according to another exemplary embodiment; and

FIG. 48 is a flow chart illustrating a method for controlling a lighting system according to another exemplary embodiment.

### DETAILED DESCRIPTION OF THE EXEMPLARY EMBODIMENTS

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a particular order. In addition, respective descriptions of well-known functions and constructions may be omitted for increased clarity and conciseness.

Exemplary embodiments will now be described in detail with reference to the accompanying drawings. Hereinafter, exemplary embodiments will be described in detail with reference to the accompanying drawings. Exemplary embodiments may, however, be embodied in many different forms and should not be construed as being limited to exemplary embodiments set forth herein. Rather, these exemplary embodiments are provided so that this disclosure will be thorough and complete and will convey the scope to those skilled in the art. In the drawings, the shapes and dimensions of elements may be exaggerated for clarity, and the same reference numerals will be used throughout to designate the same or like elements.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description of the exemplary embodiment. Thus, the terms should be defined not by simple appellations thereof but based on the meanings thereof and the context of the description of the exemplary embodiment. As used herein, expressions such as “at least one of,” when preceding a list of elements, modify the entire list of elements and do not modify the individual elements of the list.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the term “module” refers to a unit that can perform at least one function or operation and may be implemented utilizing any form of hardware, software, or a combination thereof.

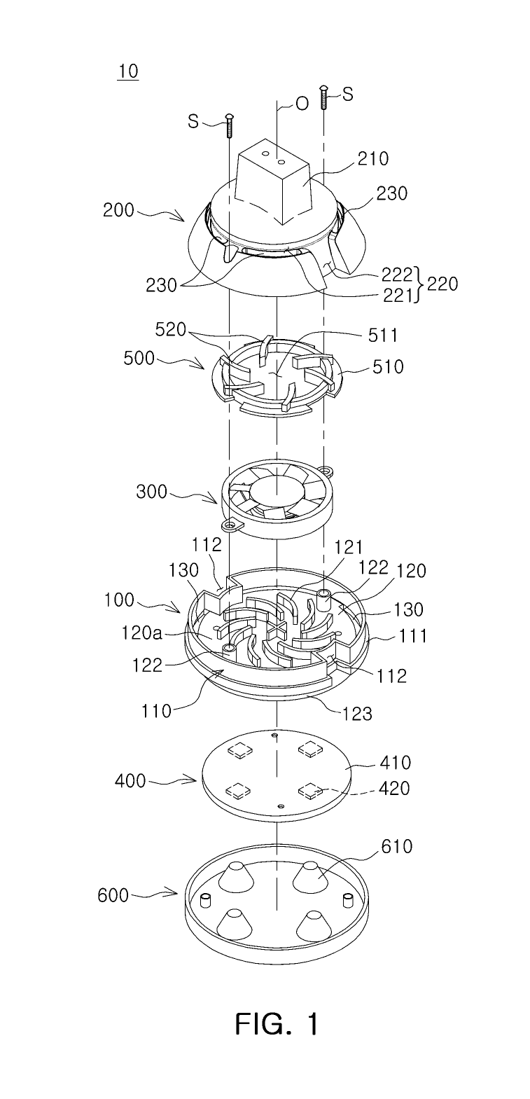

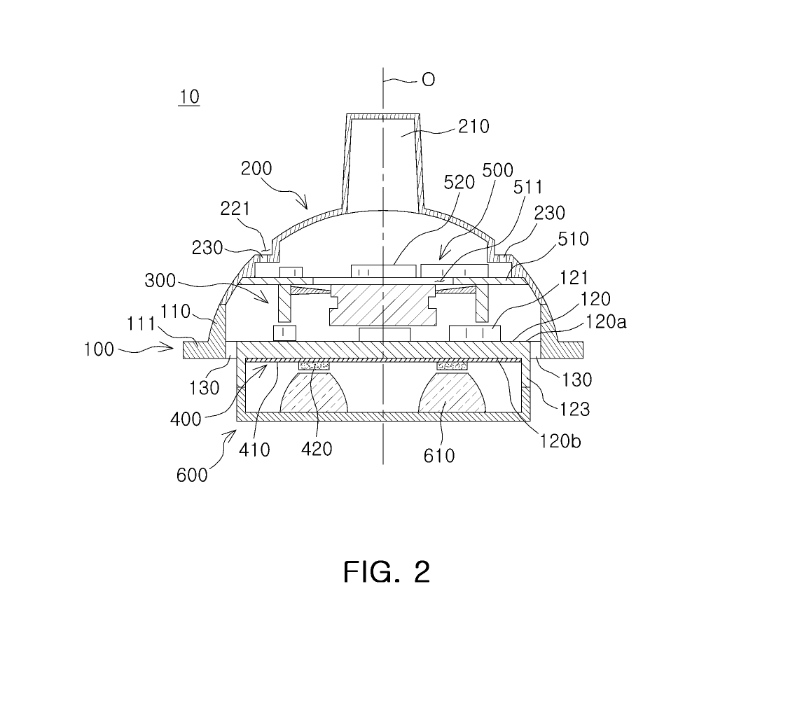

A lighting apparatus according to an exemplary embodiment will be described with reference to FIGS. 1 and 2.

FIG. 1 is an exploded perspective view schematically illustrating a lighting apparatus according to an exemplary embodiment, and FIG. 2 is a cross-sectional view schematically illustrating the lighting apparatus according to an exemplary embodiment.

Referring to FIGS. 1 and 2, a lighting apparatus 10 according to an exemplary embodiment may include a base 100, a housing 200, a cooling fan 300, and a light source module 400.

The base 100, a frame member having the cooling fan 300, and the light source module 400 mounted thereon to be fixed thereto, may be coupled by a coupling rim 110 and a supporting plate 120 provided on an inner side of the coupling rim 110.

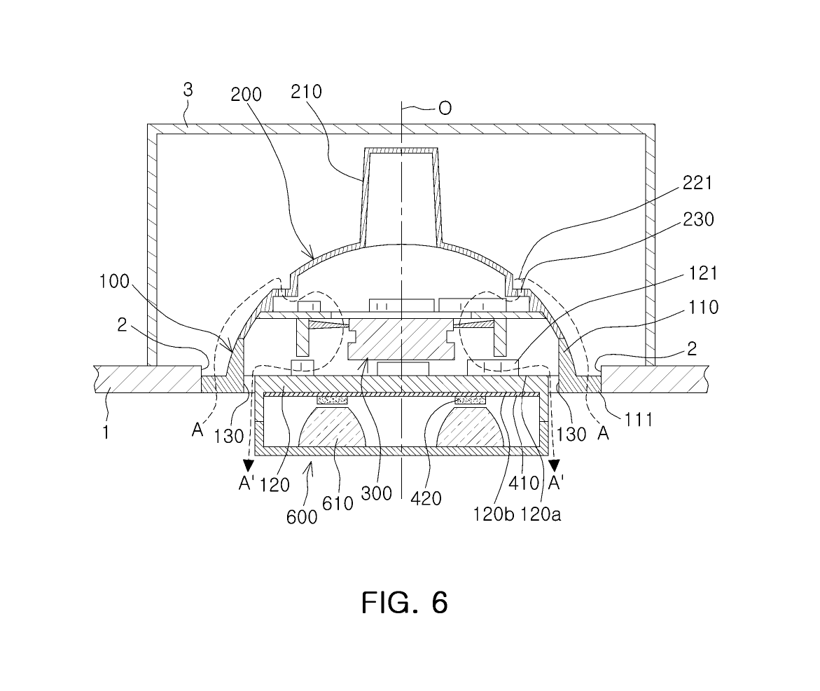

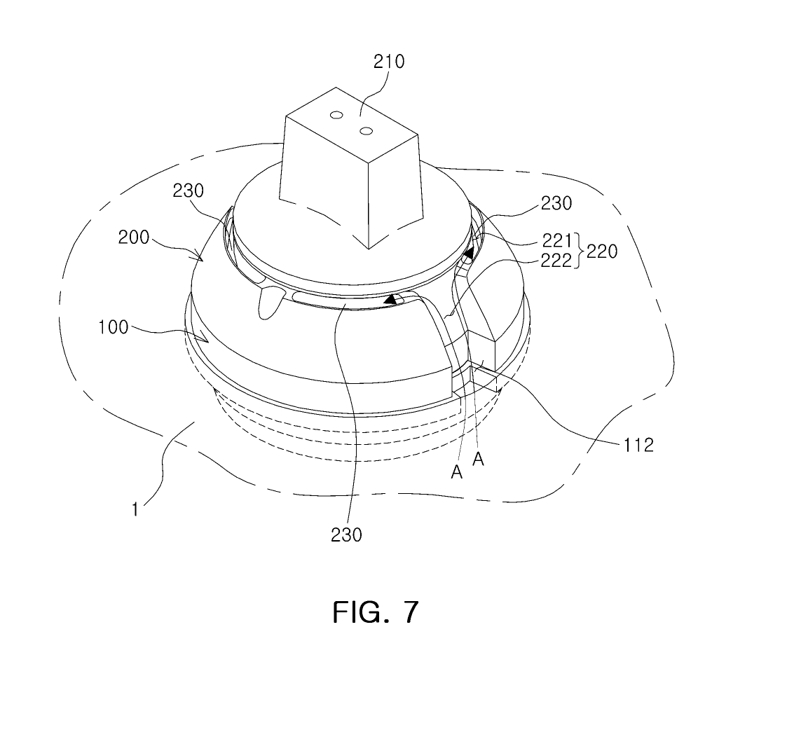

The coupling rim 110 has a ring shape perpendicular to a central axis (O), and may include a flange part 111 protruding outwardly from a lower end thereof. As illustrated in FIGS. 6 and 7, when the lighting apparatus 10 is mounted on a structure, for example, a ceiling 1, the flange part 111 may be inserted into a hole 2 provided in the ceiling 1, thereby serving to fix the lighting apparatus 10 to the ceiling 1.

The coupling rim 110 may be provided with a groove 112 depressed toward a central portion thereof. The groove 112 may have a shape corresponding to a channel part 220 of the housing 200, to be described below, and may be disposed in a position corresponding to the channel part 220 of the housing 200. By doing so, the channel part 220 may be connected to the groove 112 to be exposed to the outside through a lower portion of the coupling rim 110.

Terms used in the specification such as ‘upper portion’, ‘lower portion’, upper surface’, ‘lower surface’, and the like, are provided based on the drawings, and in practice, the terms can be varied according to a disposition direction of a lighting apparatus.

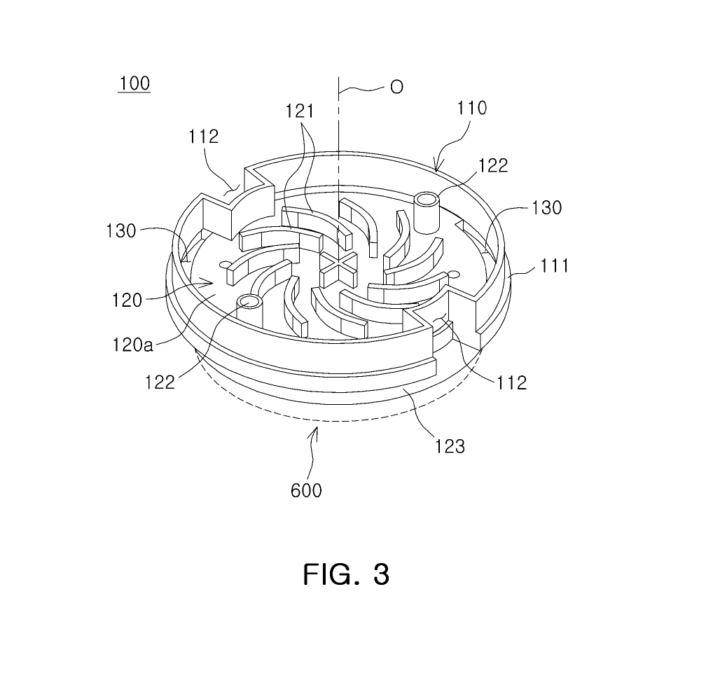

The base 100 employed in the present exemplary embodiment may be described in detail with reference to FIG. 3. As shown in FIG. 3, the supporting plate 120 may be provided on an inner circumferential surface of the coupling rim 110 in a horizontal direction, perpendicular to the central axis (O) direction, and may be partially connected to the coupling rim 110. The supporting plate 120 may have one flat surface (an upper surface) 120a and the other surface (a lower surface) 120b opposing each other, and a plurality of heat radiation fins 121 may be provided on the one surface 120a. The plurality of heat radiation fins 121 are radially arranged in a direction from a center of the supporting plate 120 toward an edge thereof. In this case, the plurality of heat radiation fins 121 respectively have curved surfaces and may be arranged in a helical shape overall. The exemplary embodiment of FIG. 3 illustrates that the plurality of heat radiation fins 121 having curved surfaces are arranged in a helical shape. However, it is understood that one or more other exemplary embodiments are not limited thereto, and the heat radiation fins 121 may have various shapes, for example, a linear shape.

The one surface 120a may have a fixing part 122 protruding therefrom to a predetermined height. The fixing part 122 may be provided with a screw hole, such that the housing 200 and the cooling fan 300, to be described below, may be fixed by a fixing mechanism such as a screw s.

The light source module 400, to be described below, may be mounted on the other surface 120b of the supporting plate 120. The other surface 120b may have a side wall 123 along an edge thereof and protruding downwardly to a predetermined depth. A space having a predetermined size is provided within an inner side of the side wall 123 to accommodate the light source module 400 therein.

The base 100 may include an air discharging hole 130 having a slit shape between an outer circumferential surface of the supporting plate 120 and an inner surface of the coupling rim 110. The air discharging hole 130 may serve as a passage allowing air to pass there through in a direction from the one surface 120a to the other surface 120b, such that air is not stagnant in a side of the one surface 120a, and maintain a continuous flow thereof.

The base 100 may be a part directly contacting the light source module 400 provided as a heat source, and thus may include a material having excellent thermal conductivity in order to perform a heat radiation function like a heat sink. For example, the base 100 in which the coupling rim 110 and the supporting plate 120 are integrally formed may be formed by injection molding using a metal or resin having excellent thermal conductivity, or the like. In addition, the coupling rim 110 and the supporting plate 120 may be individually manufactured as individual components and then assembled. In this case, the supporting plate 120 may be formed of a metal or resin having excellent thermal conductivity, while the coupling rim 110, a part grasped directly by a user during a working operation such as lighting apparatus replacement, may be formed of a material having relatively low thermal conductivity to prevent burn damage.

As in FIG. 1 and FIG. 2, the housing 200 may be coupled to one side of the base 100, in particular, to the coupling rim 110 to cover the supporting plate 120. The housing 200 has an upwardly convex parabolic shape and may include a terminal part 210 on an upper end thereof so as to be connected with an external power source (e.g., a socket) and an opening formed in a lower end thereof coupled to the base 100. In particular, the housing 200 includes the channel part 220 forming a region depressed in a stepped manner with respect to an outer surface of the housing 200 in order to guide introduction of air from the outside and an air introduction hole 230 introducing the air guided through the channel part 220 into an inner space of the housing 200.

The air introduction hole 230 may be adjacent to the upper end of the housing 200 and formed to have a ring shape along the circumference of the housing 200. The channel part 220 may include a plurality of channels, and the channel part 220 may be provided in such a manner that at least one channel is recessed in the outer surface of the housing 200 and upwardly extended along an outer side of the housing 200 from the lower end of the housing 200 to communicate with the air introduction hole 230.

Specifically, the channel part 220 may include a first channel 221 along the circumference of the housing 200 in a position corresponding to the air introduction hole 230, to communicate with the air introduction hole 230, and second channels 222 extended from the first channel 221 to the lower end of the housing 200 to be exposed to the outside. The second channels 222 may be continuously connected to the groove 112 of the coupling rim 110 coupled to the lower end of the housing 200 and may be extended to the lower portion of the coupling rim 110 to be exposed to the outside. Thus, the air introduced from the outside may be guided from the lower portion of the coupling rim 110 to the upper portion of the coupling rim 110 along a portion of the outer surface of the housing 200, that is, the channel part 220, and may be then introduced into the inner space of the housing 200 through the air introduction hole 230. The present exemplary embodiment provides that the second channel 222 may be provided in pairs, the pair of channels 222 facing each other. However, it is understood that one or more other exemplary embodiments are not limited thereto, and the number of the second channels 222 and locations thereof may be variously modified.

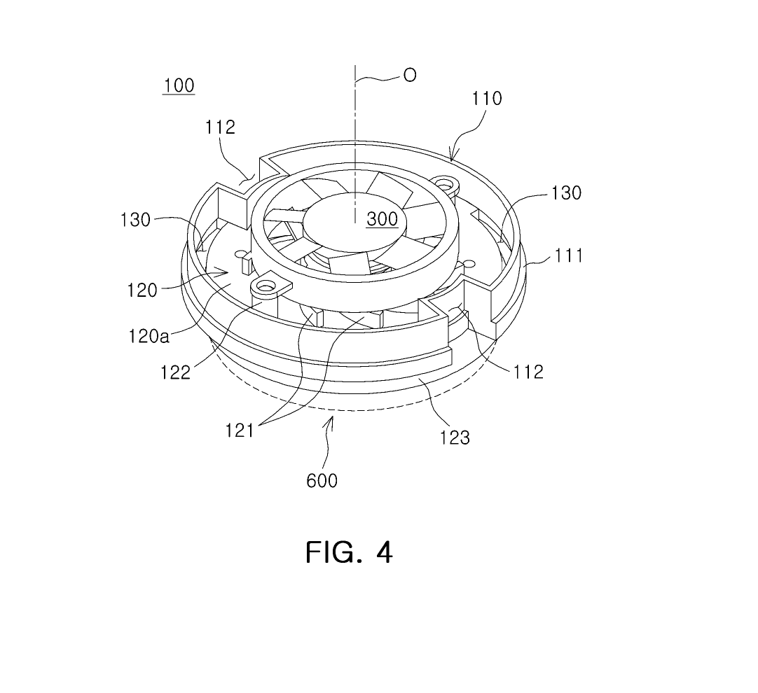

FIG. 4 schematically illustrates a disposed state of the cooling fan 300 on the base 100. As illustrated in FIG. 4, the cooling fan 300 may be provided in the housing 200. The cooling fan 300 may be disposed on one surface 120a of the supporting plate 120 and may forcibly draw the air (introduced from the outside) into the inner space of the housing 200 and discharge the in-drawn air to the outside through the air discharging hole 130. Through such forcible air flow, heat generated from the light source module 400 mounted on the base 100 may be promptly emitted to the outside, lowering a temperature of the lighting apparatus 10.

The cooling fan 300 may be disposed on the fixing part 122 of the supporting plate 120 to be supportably fixed thereto. The cooling fan 300 (specifically, an upper surface of the cooling fan 300) may be positioned to be coplanar with the air introduction hole 230 of the housing 200 or may be disposed in a position lower than the air introduction hole 230. By doing so, the air drawn into the inner space of the housing 200 through the air introduction hole 230 may pass through the cooling fan 300 and move to the base 100 to allow for a simplified air movement path, whereby the air flow may be smoothly performed to improve heat radiation efficiency.

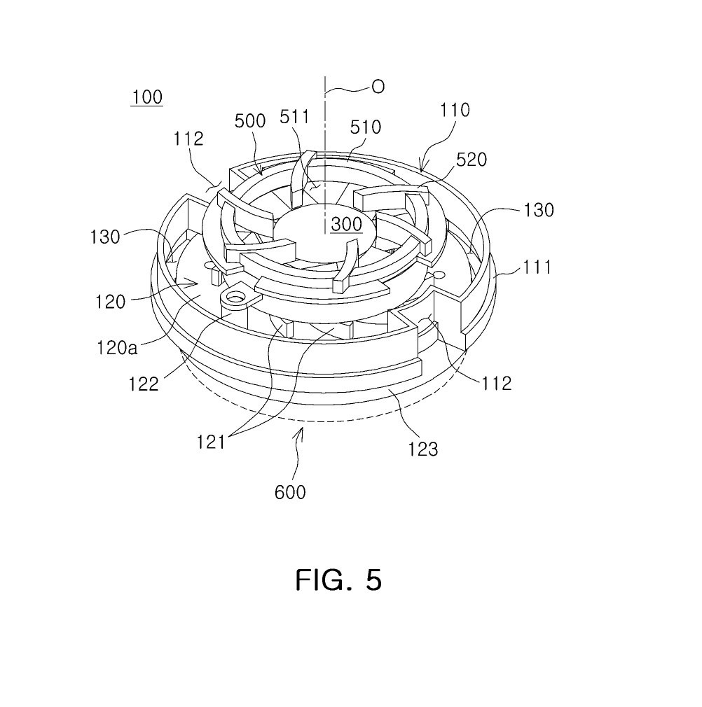

FIG. 5 schematically illustrates a disposition of a backflow prevention part 500 on the cooling fan 300. As illustrated in FIG. 5, the backflow prevention part 500 may be disposed on the cooling fan 300 and prevent the air drawn into the inner space of the housing 200 through the cooling fan 300 from flowing backward. The backflow prevention part 500 may include a ring shaped body 510 having a central hole 511 and a plurality of guide pins 520 extended to the central hole 511. The present exemplary embodiment provides that the plurality of guide pins 520 are bent to have curved surfaces and are arranged in a helical shape. However, it is understood that one or more other exemplary embodiments are not limited thereto.

The ring shaped body 510 may be provided such that an outer surface thereof contacts the inner surface of the housing 200, whereby a gap between the cooling fan 300 and the housing 200 can be blocked. The central hole 511 may have a shape corresponding to that of the cooling fan 300. The ring shaped body 510 may be positioned at least coplanarly with the air introduction hole 230 of the housing 200 or may be disposed in a position lower than the air introduction hole 230. In this case, the cooling fan 300 may be disposed in a position lower than the backflow prevention part 500. Thus, the air drawn into the inner space of the housing 200 through the air introduction hole 230 may flow to the cooling fan 300 through the central hole 511 of the ring shaped body 510.

Meanwhile, as in FIGS. 1 and 2, the light source module 400 may be mounted on the other surface 120b opposing the first surface 120a of the supporting plate 120 on which the plurality of heat radiation fins 121 are provided, and irradiate light. The light source module 400 may include a substrate 410, and at least one light emitting device 420 mounted on the substrate 410.

The substrate 410 may be a general FR4 type printed circuit board (PCB), and may include an organic resin material containing epoxy, triazine, silicon, a polyimide, or the like, and other organic resin materials. Alternatively, the substrate 410 may include a ceramic material such as AlN, Al2O3, or the like, or a metal and metal compound material, and may be a metal-core printed circuit board (MCPCB).

The light emitting device 420 may be mounted on the substrate 410 and may be electrically connected thereto. The light emitting device 420, a semiconductor device generating a predetermined wavelength of light due to external power, may include a light emitting diode (LED). The light emitting device 420 may emit blue light, green light, or red light according to a material contained therein, and may emit white light.

The light emitting device 420 may be provided in plural and the plurality of light emitting devices 420 may be arranged on the substrate 410. In this case, the plurality of light emitting devices 420 may be variously configured, such as being the same type of device that generates the same wavelength of light or different types of devices that generate different wavelengths of light. The light emitting device 420 may be LED chip, or may be a single package including LED chip therein.

Meanwhile, a cover 600 covering the substrate 410 and the light emitting devices 420 may be mounted on the base 100. The cover 600 may include a transparent or translucent material, for example, a resin such as silicon, epoxy, or the like, in order to outwardly irradiate light generated from the light source module 400, and may also include glass.

The cover 600 may include lenses 610 to correspond to the respective light emitting devices 420. The lenses 610 may be disposed to face the respective light emitting devices 420 and control an orientation angle of light generated from the light emitting devices 420. The present exemplary embodiment provides that the cover 600 has the lenses 610 provided thereon to correspond to the respective light emitting devices 420. However, it is understood that one or more exemplary embodiments are not limited thereto. The cover 600 may protrude in a convex lens shape such that the cover 600 may serve as a lens itself.

The cover 600 may contain a light diffusing agent. The light diffusing agent may have a nanometer-level particle size and include at least one material selected from among SiO2, TiO2, Al2O3, and the like.

FIGS. 6 and 7 schematically illustrate a manner in which the lighting apparatus 10 according to the present exemplary embodiment is installed on a ceiling 1. A fixing unit 3 may be installed on the ceiling 1 and may couple and fix the lighting apparatus 10 to the ceiling 1. The fixing unit 3 may supply power to the lighting apparatus 10. The lighting apparatus 10 may be fixed to an upper portion of the ceiling 1 in a hermetic state by the fixing unit 3.

As illustrated in FIG. 6 and FIG. 7, the lighting apparatus 10 may be coupled to the ceiling 1 in such a manner that the coupling rim 110 is inserted into the hole 2 of the ceiling 1. The hole 2 of the ceiling 1 may be provided to correspond to the coupling rim 110 and accordingly, a gap may not be generated between the coupling rim 110 and the hole 2, other than a space corresponding to the groove 112 of the coupling rim 110. The present exemplary embodiment illustrates that the lighting apparatus 10 is inserted into the hole 2 of the ceiling 1. However, it is understood that one or more other exemplary embodiments are not limited thereto. That is, the fixing unit 3 may be inserted and mounted in the hole 2 of the ceiling 1, and the lighting apparatus 10 may be inserted and coupled to the fixing unit 3 through the coupling rim 110. Even in this case, other than a space corresponding to the groove 112 of the coupling rim 110, a gap may not be generated between the coupling rim 110 and the groove 112.

When the cooling fan 300 disposed in the housing 200 is operated through power supplied thereto, air A is introduced from the outside through the groove 112, a space provided between the coupling rim 110 and the ceiling 1, and the introduced air A may be guided along the channel part 220 in the outer surface of the housing 200 in a direction from the lower end of the housing 200 to the upper end thereof. In addition, the air A may be drawn into the inner space of the housing 200 through the air introduction hole 230 of the housing 200. The air A drawn into the inner space of the housing 200 may be transferred to the supporting plate 120 of the base 100 through the cooling fan 300, radially dispersed to the edge of the supporting plate 120 along the heat radiation fins 121 provided on the supporting plate 120, and discharged to the outside through the air discharging hole 130. In this case, heated air A′ on the supporting plate 120 may be forcibly drawn into the housing 200 and discharged to the outside together with the flow of the air A discharged to the outside, whereby the supporting plate 120 and the light source module 400 mounted on the supporting plate 120 may be cooled. In addition, the interior of the housing 200 may be cooled due to the air A continuously drawn into the housing 200 and having low temperature. In particular, the lighting apparatus 10 according to the present exemplary embodiment may include the channel part 220 in the outer surface of the housing 200 in order to allow for the flow of the air A. Thus, even in the case in which the lighting apparatus 10 is installed within the hermetic fixing unit 3 covering the housing 200 (for example, a socket structure having a shape corresponding to that of the housing and closely attached to the outer surface of the housing), the air A introduced from the outside may be drawn into the housing 200 through a space formed due to the channel part 220. As described above, the air A introduced from the outside and having low temperature may be forcibly drawn to cool the lighting apparatus 10, whereby heat radiation efficiency may be significantly increased to improve light emitting efficiency and enhance the life span of the light source module 400.

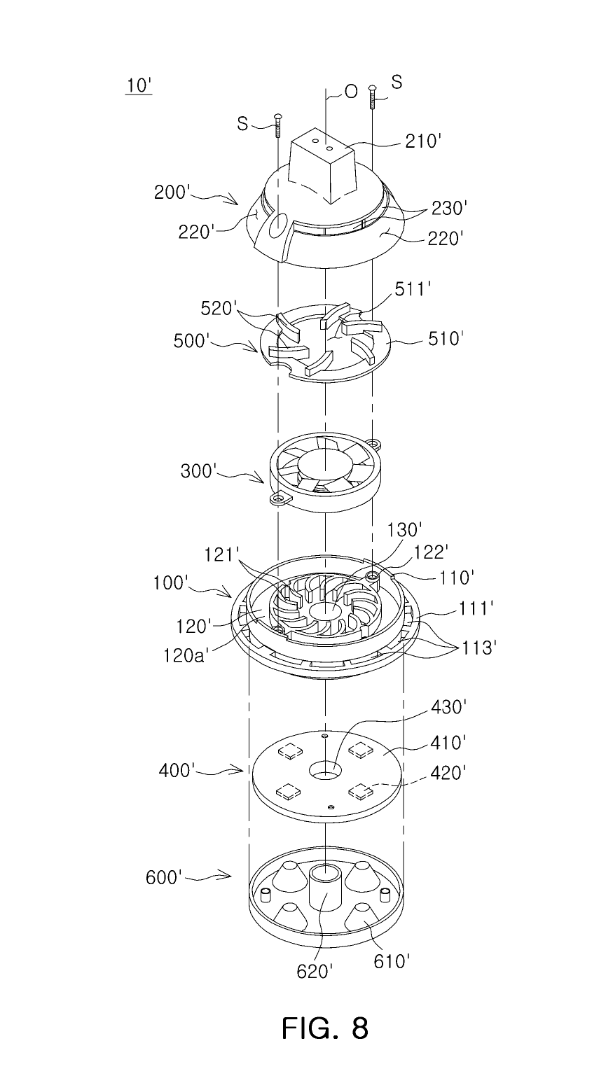

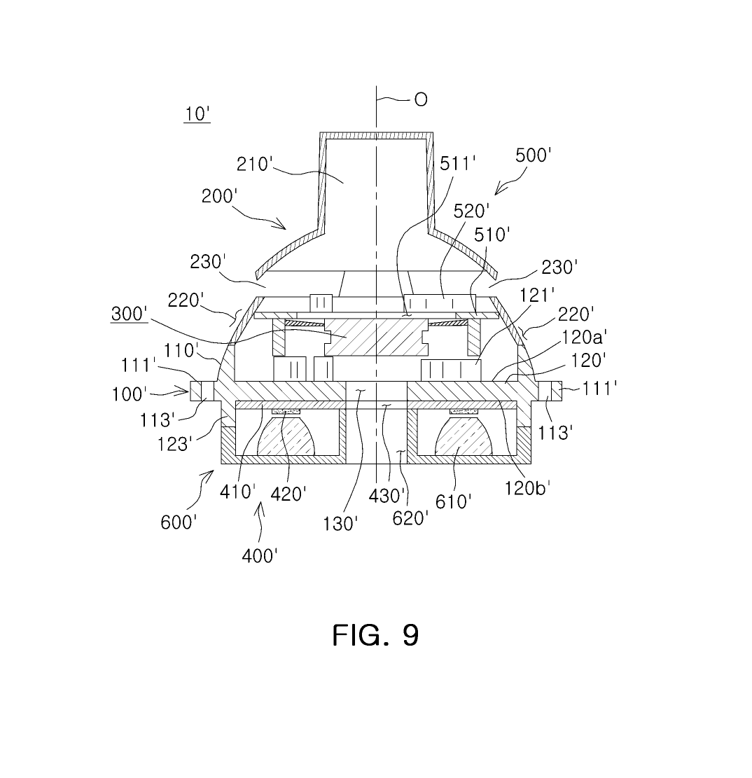

With reference to FIGS. 8 and 9, a lighting apparatus according to another exemplary embodiment will be described.

FIG. 8 is an exploded perspective view schematically illustrating a lighting apparatus according to another exemplary embodiment, and FIG. 9 is a cross-sectional view schematically illustrating a lighting apparatus according to another exemplary embodiment.

Components configuring a lighting apparatus according to another exemplary embodiment illustrated in FIGS. 8 and 9 are substantially identical or similar to those of the exemplary embodiment illustrated in FIG. 1 through FIG. 7 in terms of basic structures thereof. However, because the base and the light source module according to another exemplary embodiment have different structures from those according to the exemplary embodiment illustrated in FIG. 1 through FIG. 7, a description of components overlapping with those of the aforementioned exemplary embodiment will be omitted and configurations of the base and the light source module will be mainly described.

Referring to FIGS. 8 and 9, a lighting apparatus 10′ according to another exemplary embodiment may include a base 100′, a housing 200′, a cooling fan 300′, and a light source module 400′.

The base 100′ may include the coupling rim 110′ and the supporting plate 120′ provided on the inner side of the coupling rim 110′.

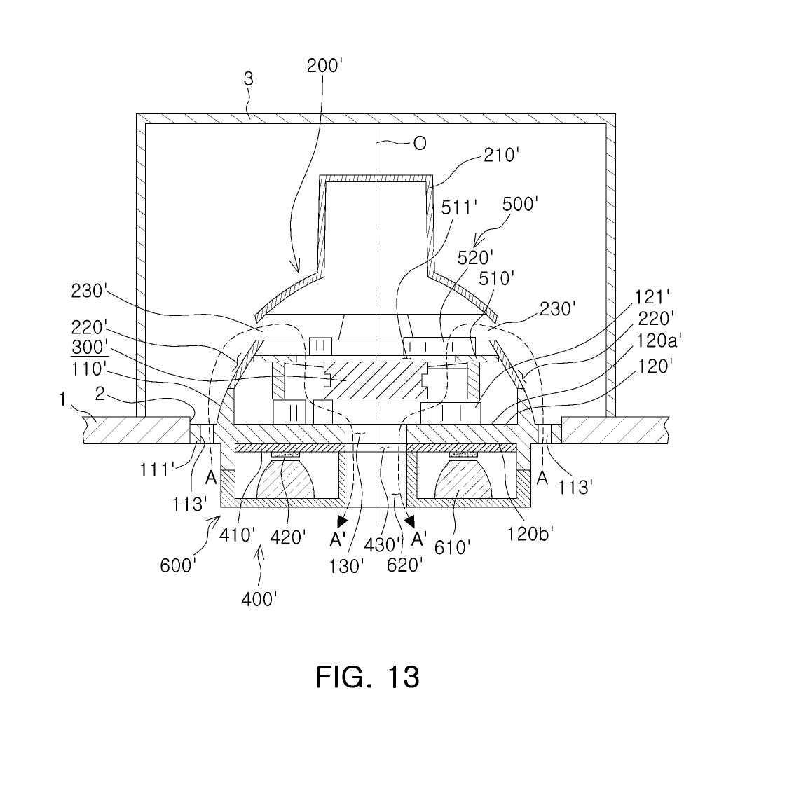

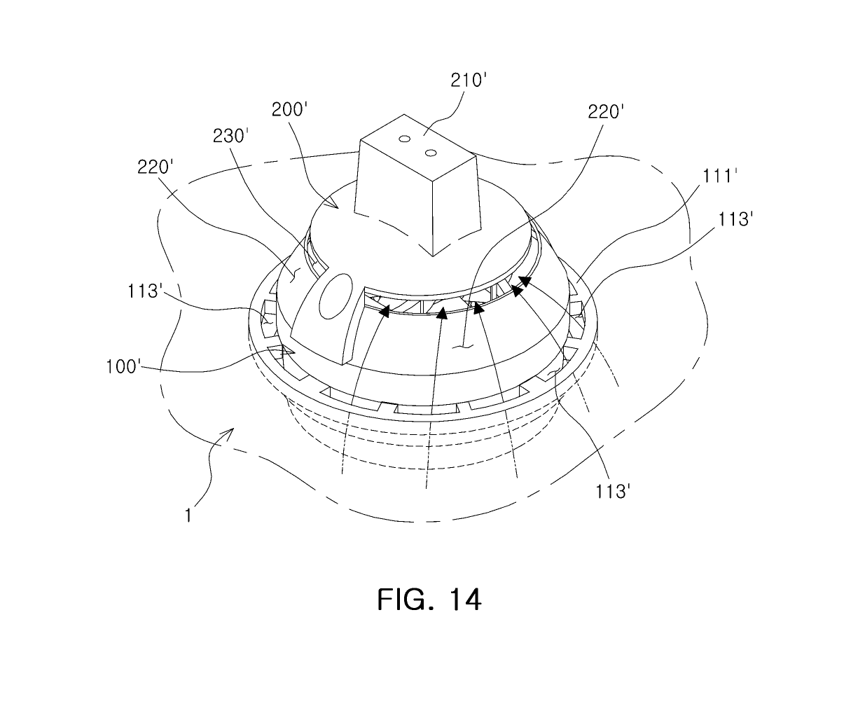

The coupling rim 110′ has a ring shape disposed to be parallel to a central axis (O), and may include the flange part 111′ protruding outwardly from the lower end thereof. As illustrated in FIGS. 13 and 14, when the lighting apparatus 10′ is mounted on a structure, for example, the ceiling 1, the flange part 111′ may be inserted into the hole 2 formed in the ceiling 1, thereby serving to fix the lighting apparatus 10′ to the ceiling 1.

The flange part 111′ may have a plurality of vents 113′ in the circumference of the coupling rim 110′. The plurality of vents 113′ may be connected to the channel part 220′ of the housing 200′, such that the air A may pass through the vents 113′ and move to the channel part 220′.

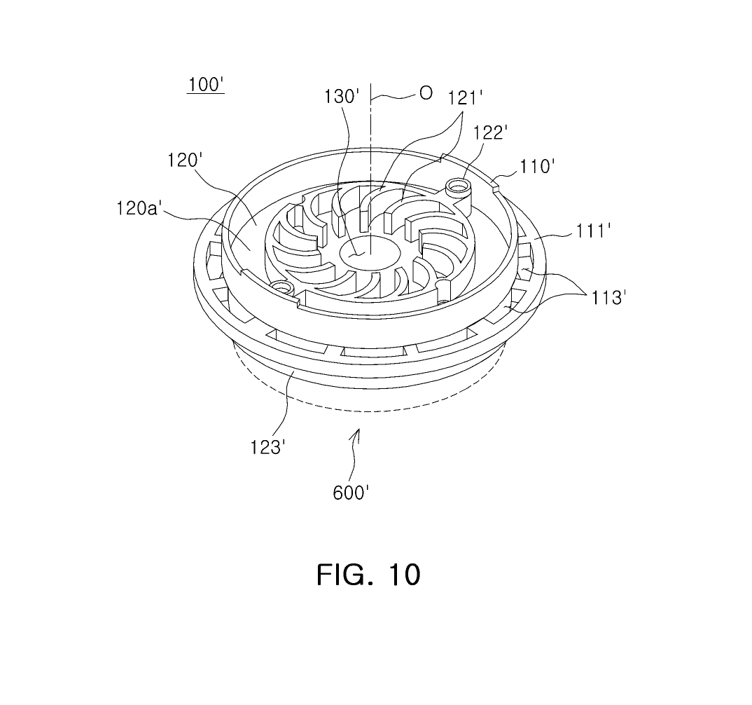

The base 100′ employed in the present exemplary embodiment will hereinafter be described in detail with reference to FIG. 10. As illustrated in FIG. 10, the supporting plate 120′ may be provided on the inner circumferential surface of the coupling rim 110′ such that it is perpendicular to the central axis (O), and the entirety of an outer circumferential surface thereof may be connected to the coupling rim 110′.

The supporting plate 120′ may have the one surface (the upper surface) 120a′ and the other surface (the lower surface) 120b′ opposing each other, and the plurality of heat radiation fins 121′ may be provided on the first surface 120a′. The plurality of heat radiation fins 121′ are radially arranged in a direction from the center of the supporting plate 120′ toward the edge thereof. In this case, the plurality of heat radiation fins 121′ respectively have curved surfaces and may be arranged in a helical shape overall. The present exemplary embodiment provides that the plurality of heat radiation fins 121′ having curved surfaces are arranged in a helical shape. However, it is understood that one or more other exemplary embodiments are not limited thereto, and the heat radiation fins 121′ may have various shapes, for example, a linear shape.

The one surface 120a′ may have the fixing part 122′ protruding therefrom to a predetermined height. The fixing part 122′ may be provided with a screw hole, such that the housing 200′ and the cooling fan 300′ may be fixed by a fixing mechanism such as the screw, s.

The light source module 400′ may be mounted on the other surface 120b′ of the supporting plate 120′. The other surface 120b′ may be provided with the side wall 123′ along the edge thereof and protruding downwardly to a predetermined depth. The space having a predetermined size is provided within the inner side of the side wall 123′ to accommodate the light source module 400′ therein.

The base 100′ may include the air discharging hole 130′ in the central portion of the supporting plate 120′. The air discharging hole 130′ may serve as a passage allowing the air A′ to pass there through in a direction from the one surface 120a′ to the other surface 120b′, such that air A is not stagnant in the side of the one surface 120a′ and maintain a continuous flow thereof.

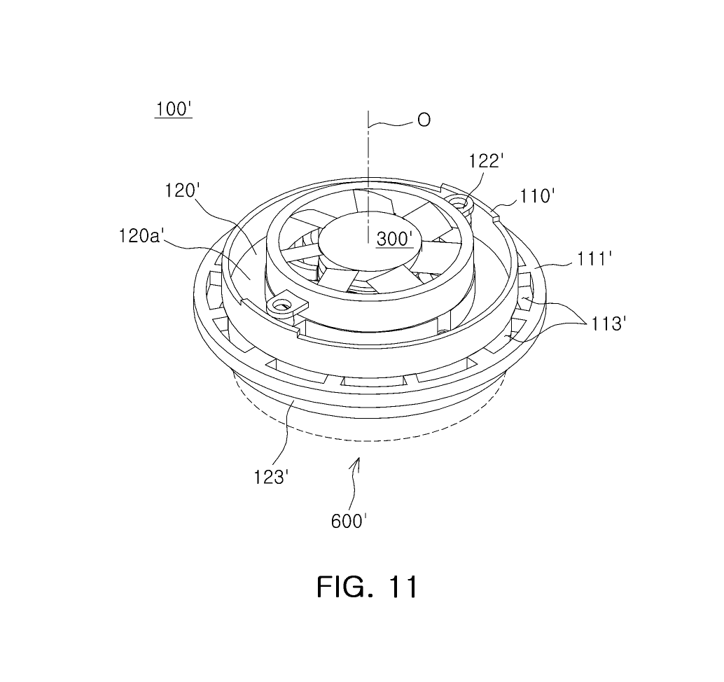

FIG. 11 schematically illustrates a state in which the cooling fan 300′ is disposed on the base 100′. As illustrated in FIG. 11, the cooling fan 300′ is disposed on the one surface 120a′ of the supporting plate 120′. The cooling fan 300′ may be fixed to the fixing part 122′.

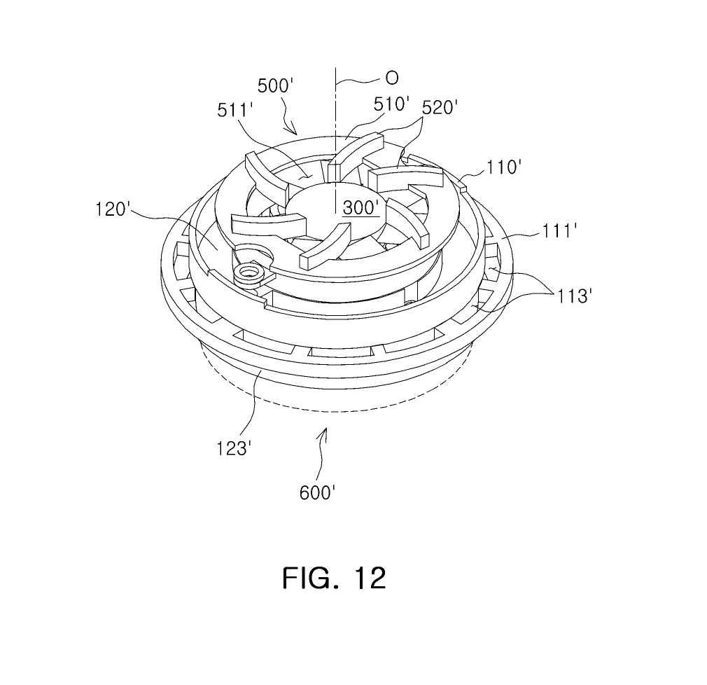

As illustrated in FIG. 12, a backflow prevention part 500′ may be disposed in an upper portion of the cooling fan 300′.

The housing 200′ may be coupled to the coupling rim 110′ of the base 100′ to cover the supporting plate 120′. The housing 200′ has an upwardly convex parabolic shape and may include the terminal part 210′ on the upper end thereof so as to be connected with a socket and an opening in the lower end thereof coupled to the base 100′. The housing 200′ includes the channel part 220′ forming a region depressed in a stepped manner with respect to the outer surface of the housing 200′ in order to guide introduction of the air A from the outside and the air introduction hole 230′ allowing the air A guided through the channel part 220′ to be introduced into the inner space of the housing 200′.

The air introduction hole 230′ may be adjacent to the upper end of the housing 200′ and may have a ring shape along the circumference of the housing 200′. The channel part 220′ may include a plurality of channels, and the channel part 220′ may be provided in such a manner that at least one channel is recessed in the outer surface of the housing 200′ to communicate with the air introduction hole 230′, and upwardly extended along the outer side of the housing 200 from the lower end of the housing 200′ to communicate with the air introduction hole 230′.

The channel part 220′ may be continuously connected to the vents 113′ of the coupling rim 110′ coupled to the lower end of the housing 200′ and may be exposed to the outside through the vents 113′. Thus, the air A introduced from the outside may pass through the vents 113′ from the lower portion of the coupling rim 110′ to be guided to the upper portion of the coupling rim 110′ along a portion of the outer surface of the housing 200′, that is, the channel part 220′, and may be then introduced into the inner space of the housing 200′ through the air introduction hole 230′. The exemplary embodiment illustrated in FIG. 8 is different from the exemplary embodiment of FIG. 1 in that the channel part 220′ of FIG. 8 may occupy the greater part of the surface area of the housing 200′. The present exemplary embodiment illustrates that the channel part 220′ may include pairs of channels facing each other, but the number of the channels of the channel part 220′ and formation location thereof may be variously modified.

The light source module 400′ may be mounted on the other surface 120b′ opposing the one surface 120a′ of the supporting plate 120′ on which the plurality of heat radiation fins 121′ are provided, and irradiate light. The light source module 400′ may include the substrate 410′ and at least one light emitting device 420′ mounted on the substrate 410′.

The substrate 410′ may be a general FR4 type printed circuit board (PCB), and may include an organic resin material containing epoxy, triazine, silicon, polyimide, or the like, and other organic resin materials. Alternatively, the substrate 410′ may include a ceramic material such as AlN, Al2O3, or the like, or a metal and metal compound material, and may be a metal-core printed circuit board (MCPCB).

The substrate 410′ may include a through hole 430′ in a position thereof corresponding to the air discharging hole 130′ of the supporting plate 120′. The light emitting devices 420′ may be arranged along the circumference of the through hole 430′.

The light emitting device 420′ may be mounted on the substrate 410′. The light emitting device 420′, a semiconductor device generating a predetermined wavelength of light due to external power applied thereto, may include a light emitting diode (LED). The light emitting device 420′ may emit blue light, green light, or red light according to a material contained therein, and may emit white light.

The light emitting device 420′ may be provided in plural and the plurality of light emitting devices 420′ may be arranged on the substrate 410′. In this case, the plurality of light emitting devices 420′ may be variously configured, such as being the same type of device that generates the same wavelength of light or different types of devices that generate different wavelengths of light. The light emitting devices 420′ may be LED chips, or may be a single package including LED chips therein.

Meanwhile, the cover 600′ covering the substrate 410′ and the light emitting devices 420′ may be mounted on the base 100′. The cover 600′ may include a transparent or translucent material, for example, a resin such as silicon, epoxy, or the like, in order to outwardly irradiate light generated from the light source module 400′, and may also include glass.

The cover 600′ may include a discharging pipe 620′ in a central portion thereof, the discharging pipe 620′ being connected to the through hole 430′ of the substrate 410′. Thus, the air A′ present within the housing 200′ may pass through the air discharging hole 130′ of the supporting plate 120′ and the through hole 430′ of the substrate 410′ to be discharged to the outside through the discharging pipe 620′.

FIGS. 13 and 14 schematically illustrate a state in which the lighting apparatus 10′ according to the present exemplary embodiment is mounted on the ceiling 1. As illustrated, the lighting apparatus 10′ may be coupled to the ceiling 1 in such a manner that the coupling rim 110′ is inserted into a hole 2 of the ceiling 1. The hole 2 of the ceiling 1 may be provided to correspond to the coupling rim 110′ and accordingly, a gap may not be generated between the coupling rim 110′ and the hole 2.

When the cooling fan 300′ disposed in the housing 200′ is operated through power supplied thereto, ambient air A is introduced through a plurality of vents 113′ provided in the flange part 111′ and guided along the channel part 220′ in the outer surface of the housing 200′ in a direction from the lower end of the housing 200′ to the upper end thereof. In addition, the air A may be drawn into the inner space of the housing 200′ through the air introduction hole 230′ of the housing 200′. The air A drawn into the inner space of the housing 200′ may be transferred to the supporting plate 120′ of the base 100′ through the cooling fan 300′, may pass through the air discharging hole 130′ of the supporting plate 120′ and the through hole 430′ of the substrate 410′, and may be discharged to the outside through the discharging pipe 620′. In this case, heated air A′ on the supporting plate 120′ may be forcibly drawn into the housing 200′ and discharged to the outside together with the flow of the air discharged to the outside, thereby cooling the supporting plate 120′ and the light source module 400′ mounted on the supporting plate 120′.

Although the lighting apparatus 10′ according to an exemplary embodiment is inserted and fixed such that no gap is generated between the hole 2 of the ceiling 1 and the coupling rim 110′, ambient air A can be drawn through the vent 113′ provided in the flange part 111′, and even when the lighting apparatus 10′ is fastened to an airtight fixing unit 3 like a socket structure, ambient air A may be forcibly introduced through a space formed by the channel part 220′ provided in the surface of the housing 200′ to cool the lighting apparatus 10′.

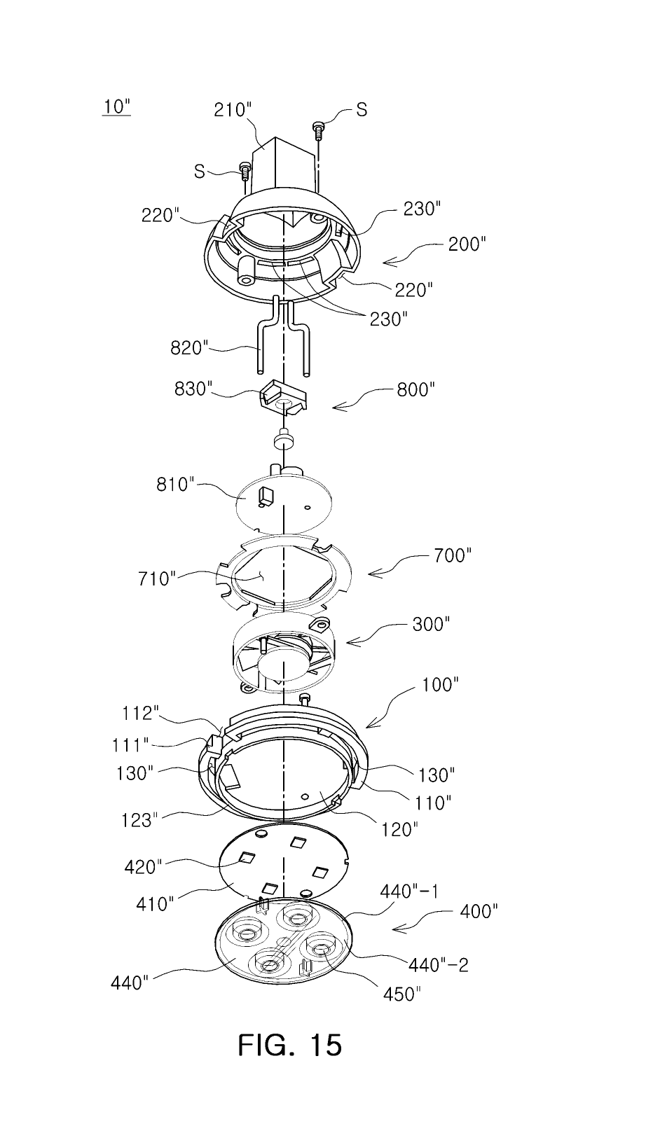

A lighting apparatus according to another exemplary embodiment will be described with reference to FIGS. 15 through 21.

Components constituting the lighting apparatus according to the exemplary embodiment illustrated in FIG. 15 through FIG. 21 are substantially identical or similar to those of the exemplary embodiment illustrated in FIG. 1 through FIG. 7 in terms of the basic structures thereof, except for the structure of a light source. Thus, a description of the same components as those of the foregoing exemplary embodiment will be omitted and a configuration of a light source module will be largely described.

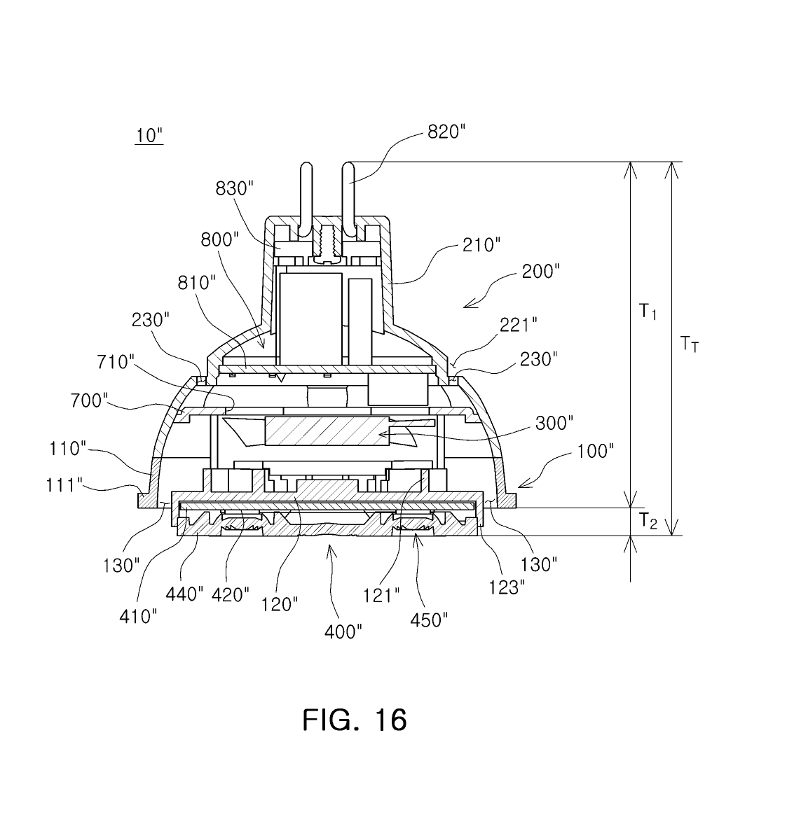

As illustrated in FIGS. 15 and 16, a lighting apparatus 10″ according to the present exemplary embodiment may include a base 100″, a housing 200″, a cooling fan 300″, and a light source module 400″.

The base 100″ may include a coupling rim 110″ and a supporting plate 120″ provided in an inner side of the coupling rim 110″, and may further include an air discharging hole 130″ formed as a slit between an outer circumferential surface of the supporting plate 120″ and an inner surface of the coupling rim 110″.

The housing 200″ may be disposed on one side of the base 100″, and coupled to the coupling rim 110″ to cover the support plate 120″. The housing 200″ includes a channel part 200″ forming a region depressed in a stepped manner with respect to an outer surface of the housing 200″ in order to guide the introduction of air and an air introduction hole 230″ introducing the air guided through the channel part 220″ to an inner space of the housing 200″.

The cooling fan 300″ provided within the housing 200″ forcibly draws air into the inner space of the housing 200″ and discharges the in-drawn air to the outside through the air discharging hole 130″ provided in the base 100″.

The base 100″, the housing 200″, and the cooling fan 300″ are the same as constituent members and structure of the lighting apparatus 10 according to the exemplary embodiment of FIG. 1, so a detailed description thereof will be omitted.

Meanwhile, a spacer 700″ may be provided on the cooling fan 300″ in order to stop a gap between the cooling fan 300″ and the housing 200″. The spacer 700″ may have an annular shape with a central hole 710″ formed therein, and an outer circumferential surface thereof is in contact with an inner surface of the housing 200″. The central hole 710″ may have a size and shape corresponding to the cooling fan 300″. Thus, air drawn into the interior through the air introduction hole 230″ of the housing 200″ wholly flows to the cooling fan 300″ through the central hole 710″.

As illustrated in FIGS. 15 and 16, a power supply unit (PSU) 800″ may be accommodated in a terminal part 210″ of the housing 200″ to supply external power to the light source module 400″. The power supply unit 800″ may include a driving circuit 810″ including a capacitor, or the like, and an electrode pin 820″ connected to the driving circuit 810″ and protruded outwardly from the terminal part 210″. The electrode pin 820″ may be fixed through a pin holder 830″.

The power supply unit 800″ may be disposed in a position higher than the air introduction hole 230″ of the housing 200″, and thus, air drawn into the inner space of the housing 200″ through the air introduction hole 230″ immediately flows to the base 100″ through the cooling fan 300″. In this case, heat generated by the power supply unit 800″ may be outwardly radiated by the drawing air A.

The light source module 400″ is installed in the supporting plate 120″ and emits light through power applied through the power supply unit 800″. The light source module 400″ according to the present exemplary embodiment may include at least one light emitting device 420″ and a lens unit 440″ disposed on the light emitting device 420″ and having a lens 450″. The light source module 400″ may further include a substrate 410″ on which the light emitting device 420″ is mounted.

The lens unit 440″ may be disposed on the other side of the base 100″ to cover the substrate 410″ and the plurality of light emitting devices 420″. The lens unit 440″ may protect the light emitting device 420″ from an ambient environment, or in order to improve light extraction efficiency of light emitted outwardly from the light emitting device 420″, the lens unit 440″ may be made of a light-transmissive material. For example, the light-transmissive material may include polycarbonate (PC), polymethylmethacrylate (PMMA), acryl, and the like. Also, the lens unit 440″ may be made of a glass material, according to one or more exemplary embodiments.

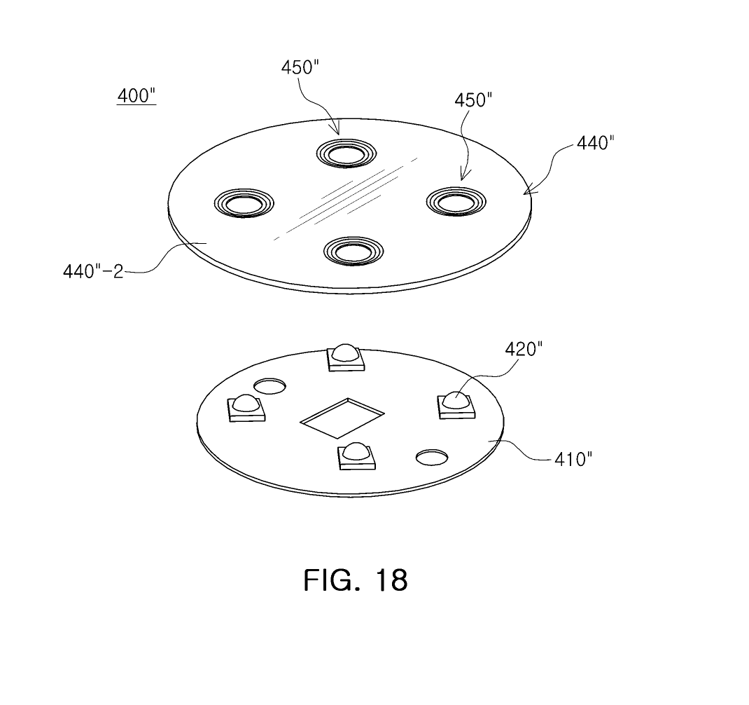

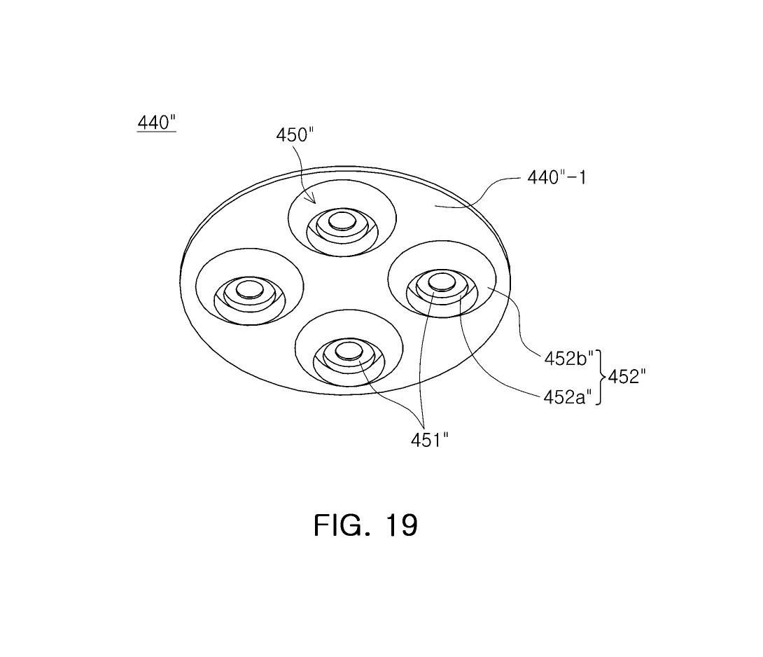

FIG. 18 schematically illustrates the light source module 400″, and FIG. 19 schematically illustrates the lens unit 440″ of the light source module 400″.

As illustrated in FIGS. 18 and 19, the lens unit 440″ may have a first surface 440″-1 facing the light emitting device 420″ and a second surface 440″-2 opposing the first surface 440″-1. The lens unit 440″ may include a plurality of lenses 450″ disposed to oppose the light emitting devices 420″, respectively. The plurality of lenses 450″ may be disposed on the light emitting devices 420″, respectively, to adjust regions in which light generated by the light emitting devices 420″ is irradiated outwardly. The plurality of lenses 450″ may be integrally connected to form the lens unit 440″.

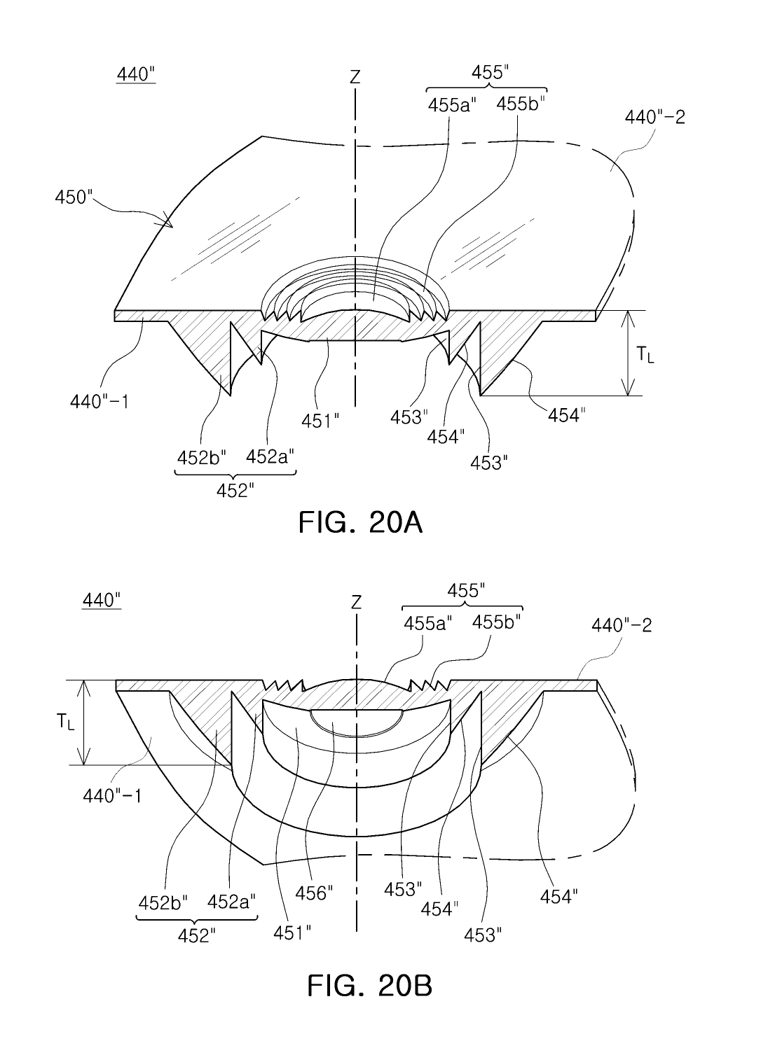

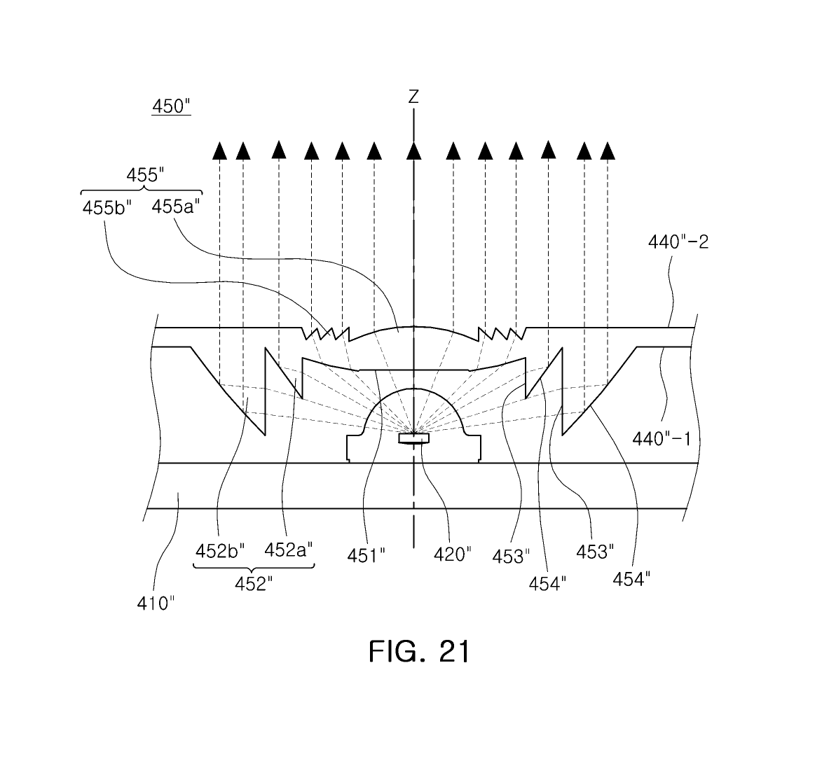

The lens 450″ employed in the present exemplary embodiment will be described in more detail with reference to FIGS. 20 and 21. As illustrated in FIGS. 20 and 21, the lens 450″ may be provided on the first surface 440″-1 and have a central incident surface 451″ to which light from the light emitting device 420″ is made incident and a reflective portion 452″ protruding toward the light emitting device 420″ along the circumference of the central incident surface 451″ and being symmetrical with regard to a central optical axis Z. The lens 450″ may have a refractive portion 455″ provided on the second surface 440″-2 and protruded in the opposite direction of the light emitting device 420″ and being symmetrical with regard to the optical axis Z.

The central incident surface 451″ may be disposed immediately above the light emitting device 420″ such that it is perpendicular with respect to the optical axis Z passing through the center, and may have a flat planar shape or a gentle curved shape overall. The central incident surface 451″ may have a depressed portion 456″ having a step structure. The depressed portion 456″ may have a shape corresponding to an ejection pin as described hereinafter and come into contact with the ejection pin.

The reflective portion 452″ may have an annular shape along the circumference of the edge of the central incident surface 451″ such that it encircles the central incident surface 451″ and may have a first reflective portion 452a″ and a second reflective portion 452b″ which are concentric and have different rotational radii with respect to the optical axis Z. For example, the first reflective portion 452a″ is provided along the circumference of the edge of the central incident surface 451″ to cover the central incident surface 451″, and the second reflective portion 452b″ may be provided along the circumference of the edge of the first reflective portion 452a″ to cover the first reflective portion 452a″. The first and second reflective portions 452a″ and 452b″ may have annular shapes having different diameters with respect to the optical axis Z.

The first reflective portion 452a″ and the second reflective portion 452b″ may have a side incident surface 453″ to which light from the light emitting device 420″ is incident and a reflective surface 454″ which reflects the incident light to the second surface 440″-2, respectively.

The side incident surface 453″ may receive light irradiated in a lateral direction, which is included in light from the light emitting device 420″, and to this end, the side incident surface 453″ may protrude from the first surface 440″-1 toward the light emitting device 420″ to extend along the optical axis Z by a predetermined distance.

The reflective surface 454″ reflects light received through the side incident surface 453″ toward the second surface 440″-2, and to this end, the reflective surface 454″ may have a paraboloid shape connecting an extending end of the side incident surface 453″ and the first surface 440″-1.

In the present exemplary embodiment, it is illustrated that the reflective surface 454″ has a paraboloid shape, but all exemplary embodiments are not limited thereto. For example, the reflective surface 454″ may have a linear sloped shape and may be freely modified to have a shape as long as it can reflect light received through the side incident surface 453″ toward the second surface 440″-2.

Meanwhile, the reflective portion 452″ may have a structure in which a length thereof protruded from the first surface 440″-1 is increased in a direction away from the optical axis Z. Namely, the second reflective portion 452b″ is protruded by a greater amount than the first reflective portion 452a″ toward the light emitting device 420″, and thus, the second reflective portion 452b″ may be greater in size than the first reflective portion 452a″ overall.

In the present embodiment, the reflective portion 452″ has a dual-ring structure including the first and second reflective portions 452a″ and 452b″, but all exemplary embodiments are not limited thereto. For example, the reflective portion 452″ may further include a third reflective portion (not shown) having a size and a diameter greater than those of the second reflective portion 452b″, having a triple ring structure or more.

The second surface 440″-2 opposing the first surface 440″-1 is a light output surface emitting light, incident to the first surface 440″-1, to the outside. The second surface 440″-2 includes the refractive portion 455″ protruded in a direction opposite the light emitting device 420″ and being symmetrical with regard to the optical axis Z.

The refractive portion 455″ may include a first refractive portion 455a″ and a second refractive portion 455b″ surrounding the first refractive portion 455a″.

The first refractive portion 455a″ may be disposed immediately above the light emitting device 420″, and may have a convexly curved surface using the optical axis Z as an apex. The second refractive portion 455b″ forms a plurality of concentric circles with respect to the optical axis Z and may have a convexo-concave structure formed along the circumference of the first refractive portion 455a″. The convexo-concave form of the second refractive portion 455b″ may include a Fresnel pattern, for example.

The refractive portion 455″ may be formed by performing an intaglio process the flat second surface 440″-2. Namely, the curved surface of the first refractive portion 455a″ and the convexo-concave shape of the second refractive portion 455b″ may be coplanar with at least the second surface 440″-2 or may be lower than the second surface 440″-2. Thus, the refractive portion 455″ may not be protruded from the second surface 440″-2 and a height (or thickness) TL of the lens 450″ may be defined as a distance between an end of the reflective portion 452″ protruded from the first surface 440″-1 and the second surface 440″-2.

In the present exemplary embodiment, the case in which the refractive portion 455″ is not protruded from the second surface 440″-2 is illustrated, but all exemplary embodiments are not limited thereto. For example, the refractive portion 455″ may be partially protruded upwardly from the second surface 440″-2. However, a degree of protrusion thereof is merely a portion with respect to the overall height (or thickness) TL of the lens 450″, so it does not affect the height TL of the lens 450″.

Meanwhile, the lens 450″ may have a structure in which the reflective portion 452″ is disposed outwardly of the refractive portion 455″ with regard to the optical axis Z to surround the refractive portion 455″. In detail, the central incident surface 451″, opposing the refractive portion 455″ formed on the second surface 440″-2, is formed to have a size corresponding to the refractive portion 455″, and accordingly, the reflective portion 452″ may be disposed outwardly of the refractive portion 455″ to surround the refractive portion 455″.

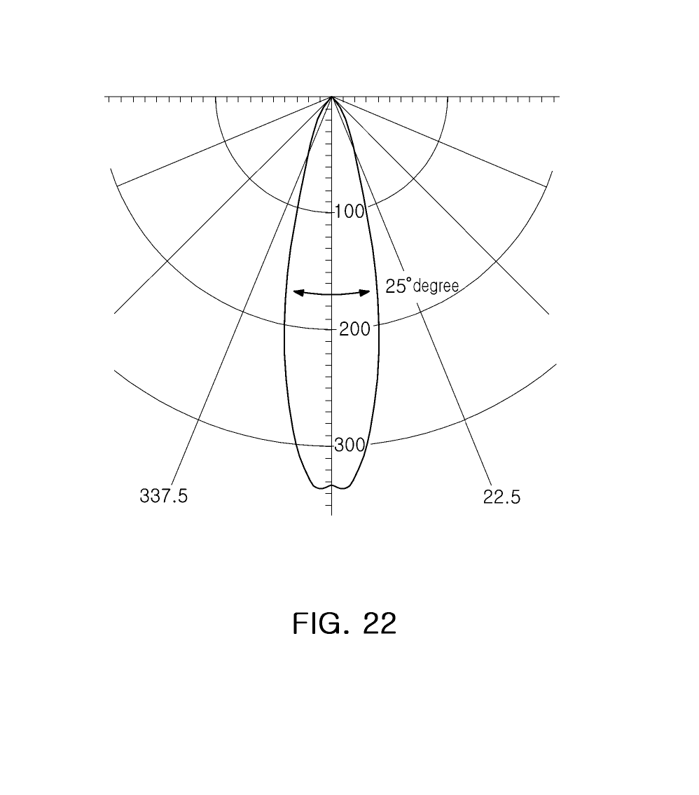

FIG. 22 is a graph showing a light distribution curve of the lens 450″. As illustrated, it can be seen that a beam spread angle of concentrated light ranges from about 24° to 25°. This means that it does not have any significant difference in concentration capability, in comparison to the related art condensing lens having a beam spread angle of about 24.4°.

The lens 450″ may be integrally formed with the lens unit 440″ by injecting a fluidic solvent into a mold and solidifying it. For example, it may include a scheme such as injection molding, transfer molding, compression molding, and the like.

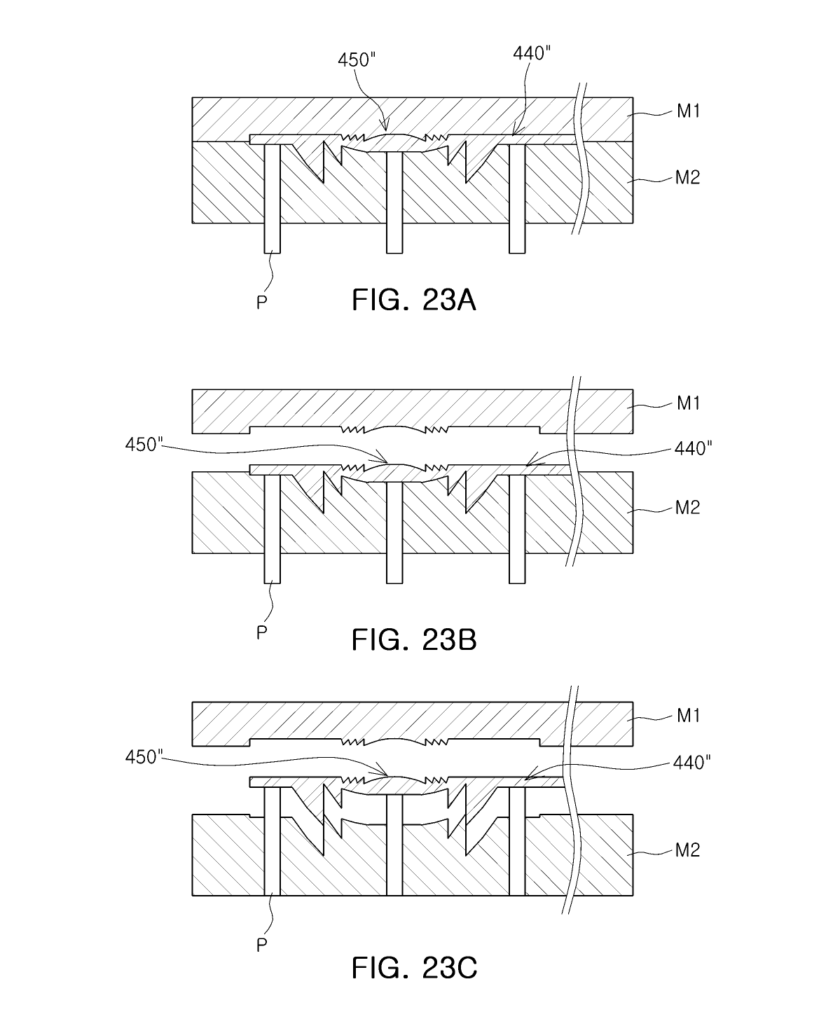

FIGS. 23A through 23C schematically illustrate a process of fabricating the lens unit having the lens using a mold. FIGS. 23A through 23C are cross-sectional views schematically illustrating a sequential process of fabricating the lens unit according to the present exemplary embodiment.

First, as illustrated in FIG. 23A, molds M1 and M2 having a lens shape are prepared, and a fluidic solvent, e.g., a resin, is injected into the molds M1 and M2 and cured to complete the lens unit 440″ having the lens 450″.

Next, as illustrated in FIG. 23B, the molds M1 and M2 are separated to allow the completed lens unit 440″ to be partially separated from the molds M1 and M2.

Then, as illustrated in FIG. 23C, the lens unit 440″ is completely separated from the molds M1 and M2 through ejection pins P provided in the molds M1 and M2. At least three or more ejection pins P may be provided, whereby deformation of the lens unit 440″ in the course of separating the lens unit 440″ can be minimized. For example, the ejection pins P may be configured to be in contact with the both edge regions of the lens 450″ and a central region of the lens 450″, such that force applied to the lens 450″ is evenly distributed. In this case, the ejection pin P disposed to be in contact with the central region of the lens 450″ may be in contact with the depressed portion 456″ formed in the central incident surface 451″ of the lens 450″.

Namely, in case of the related art condensing lens, because it has a thickness to a degree (e.g., approximately 10 mm), the ejection pin may be disposed outwardly of the lens in the event of ejection molding. However, in the case in which the lens 450″ has a small thickness (i.e., height) as in the present exemplary embodiment, the lens 450″ may be deformed. Thus, the ejection pin P is disposed even in the central portion to allow force applied to the lens 450″ to be uniformly distributed to prevent deformation of the lens unit 440″.

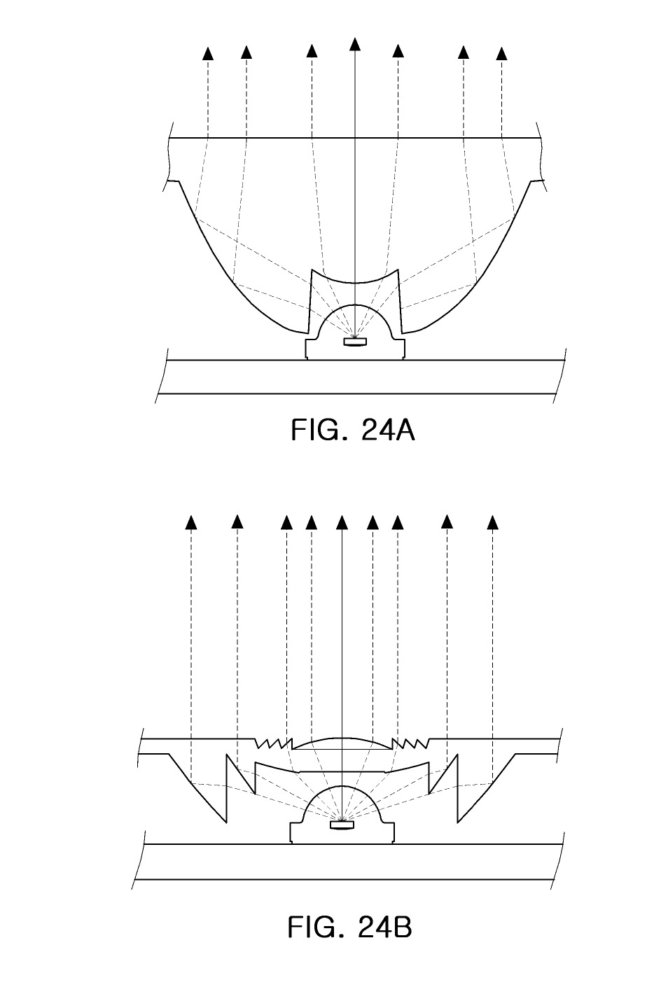

The lens 450″ according to the present exemplary embodiment fabricated thusly may have a thickness (or height) ranging from about 2 mm to 4.5 mm as illustrated in FIG. 20. Namely, the lens 450″ according to the present exemplary embodiment may have a thickness equal to about half that of the existing condensing lens (having a thickness equal to about 10 mm, please see FIG. 24A), implementing a small size suitable for compactness, and when the lens 450″ according to the present exemplary embodiment is employed in a lighting apparatus, it may have a size that falls within the range set by the American National Standards Institute (ANSI) (ANSI C78.24-2001).

For example, the lamp standard (ANSI C78.24-2001) stipulated by the ANSI requests that a light lamp having the structure illustrated in FIG. 16 should follow standard of T1: 46 mm, T2: 4.5 mm, TT: 50.5 mm at the maximum.

In a high output lamp, such as a current 50 W MR 16 product, which has difficulty in implementing sufficient cooling with natural heat radiation (or dissipation) scheme, the use of a cooling fan is essential. In this case, a size of a product due to the installation of a cooling fan is increased to exceed the ANSI standard.

In case of a housing limited to the dimension of T1, it has a standardized structure for its fastening to a socket, and the like. Thus, in the present exemplary embodiment, a lens limited the dimension of T2 is reduced in thickness to avoid exceeding the ANSI standard. FIGS. 24A and 24B show the comparison between a general condensing lens and the slim-type lens according to the present exemplary embodiment. As can be seen from the drawings, the light lamp having a height (or thickness) reduced by about half, while maintaining the same optical characteristics, in compliance with the ANSI standard, can be implemented.

Meanwhile, the substrate 410″ corresponds to a base member constituting a circuit board on which the light emitting device 420″ as an electronic device is to be mounted, and it may be a so-called a printed circuit board (PCB). Also, the substrate 410″ may be a package body supporting the light emitting device 420″, as a base member.

The substrate 410″ may be made of, for example, a material such as FR-4, CEM-3, or the like, but all exemplary embodiments are not limited thereto. For example, the substrate 410″ may also be made of glass or an epoxy material, a ceramic material, or the like. Also, the substrate 410″ may be made of a metal or a metal compound or may include a metal core printed circuit board (MCPCB), a metal copper clad laminate (MCCL), or the like.

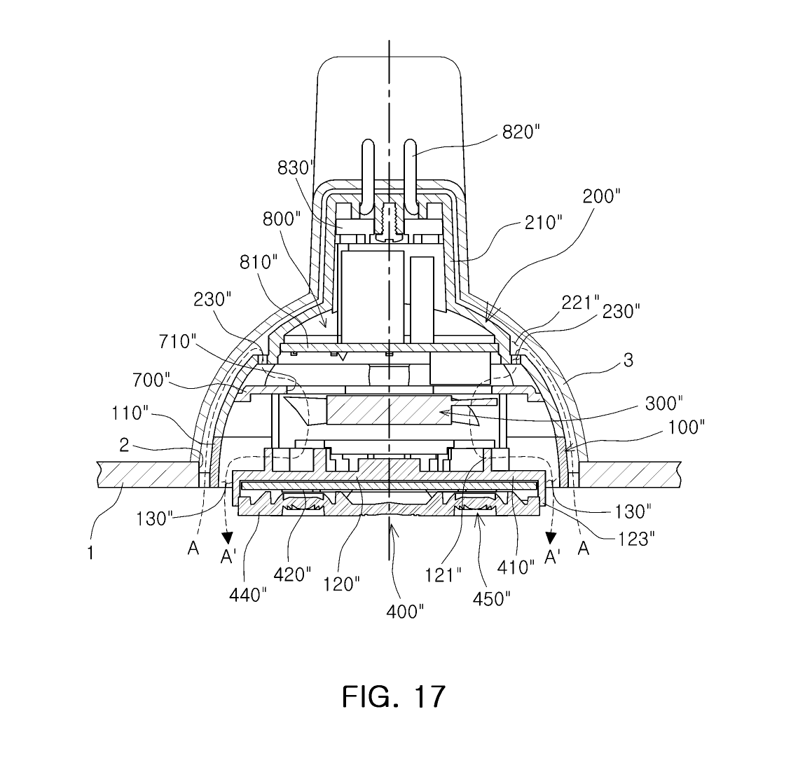

FIG. 17 schematically illustrates a state in which the lighting device 10″ according to the present exemplary embodiment is installed on the ceiling 1. The fixing unit 3 may be installed on the ceiling 1 to fasten or fix the lighting apparatus 10″, and power may be supplied to the lighting apparatus 10″. The lighting apparatus 10″ may be fixed to an upper portion of the ceiling 1 by the fixing unit 3 in an airtight state.

As illustrated, the lighting apparatus 10″ may fastened to the ceiling 1 such that the coupling rim 110″ is inserted into the hole 2 of the ceiling 1. The hole 2 of the ceiling 1 may be provided to correspond to the coupling rim 110″, and accordingly, a gap may not be generated between the coupling rim 110″ and the hole 2, other than a space corresponding to the groove 112″ of the coupling rim 110″.

When the cooling fan 300″ disposed in the housing 200″ is operated through power supplied thereto, air A is introduced from the outside through the groove 112″, a space provided between the coupling rim 110″ and the ceiling 1, and the introduced air A may be guided along the channel part 220″ in the outer surface of the housing 200″ in a direction from the lower end of the housing 200″ to the upper end thereof. In addition, the air A may be drawn into the inner space of the housing 200″ through the air introduction hole 230″ of the housing 200″. The air A drawn into the inner space of the housing 200″ may flow to the supporting plate 120″ of the base 100″ through the spacer 700″ and the cooling fan 300″, radially dispersed to the edge of the supporting plate 120″ along the heat radiation fins 121″ provided on the supporting plate 120″, and discharged to the outside through the air discharging hole 130″. In this case, heated air A′ on the supporting plate 120″ may be forcibly drawn into the housing 200″ and discharged to the outside together with the flow of the air A discharged to the outside, whereby the supporting plate 120″ and the light source module 400″ mounted on the supporting plate 120″ may be cooled. In addition, the interior of the housing 200″ may be cooled due to the air A continuously drawn into the housing 20 and having a relatively low temperature. In particular, the lighting apparatus 10″ according to the present exemplary embodiment may include the channel part 220″ in the outer surface of the housing 200″ in order to allow for the flow of the air A. Thus, even in the case in which the lighting apparatus 10″ is installed within the airtight fixing unit 3 covering the housing 200″ (for example, a socket structure having a shape corresponding to that of the housing and closely attached to the outer surface of the housing), the air A introduced from the outside may be drawn into the housing 200″ through a space formed due to the channel part 220″. As described above, the air A introduced from the outside and having a relatively low temperature may be forcibly drawn in to cool the lighting apparatus 10″, maximizing heat radiation efficiency, and thus, the life span of the light source module 400″ can be lengthened and luminous efficiency can be enhanced.

Hereinafter, various substrate structures employable in light source modules according to various exemplary embodiments as described above will be described.

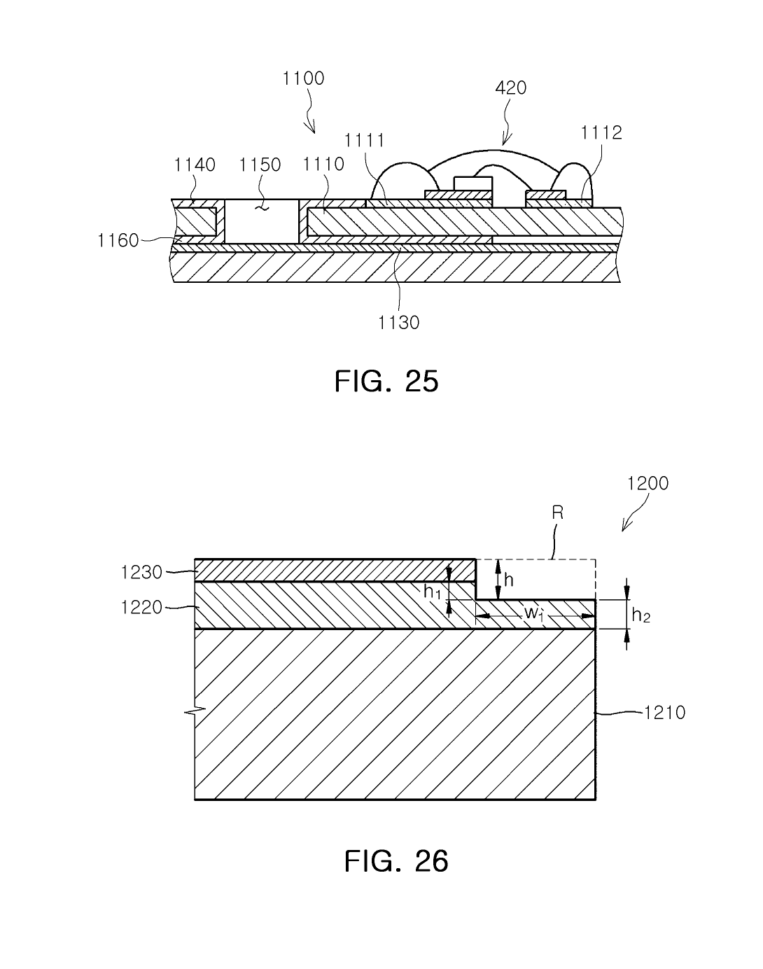

As illustrated in FIG. 25, a board 1100 may include an insulating substrate 1110 having predetermined circuit patterns 1111 and 1112 formed on one surface thereof, an upper heat diffusion plate 1140 formed on the insulating substrate 1110 such that it is in contact with the circuit patterns 1111 and 1112 and dissipating heat generated by the light emitting device 420, and a lower heat diffusion plate 1160 formed on the other surface of the insulating substrate 1110 and outwardly diffusing heat transmitted by the upper heat diffusion plate 1140. The upper heat diffusion plate 1140 and the lower heat diffusion plate 1160 may be connected by at least one through hole 1150 penetrating the insulating substrate 1110 and having a plated inner wall.

The circuit pattern 1111 and 1112 of the insulating substrate 1110 may be formed by coating copper foil on a ceramic or epoxy resin-based FR4 core and performing an etching process thereon. An insulating thin film 1130 may be coated on a lower surface of the board 1100.

FIG. 26 illustrates another example of the board. As illustrated in FIG. 26, a board 1200 may include an insulating layer 1220 formed on a first metal layer 1210 and a second metal layer 1230 formed on the insulating layer 1220. The substrate 1200 may have a step portion ‘R’ formed in at least one end portion thereof and allowing the insulating layer 1220 to be exposed.

The first metal layer 1210 may be made of a material having excellent exothermic characteristics. For example, the first metal layer 1210 may be made of a metal such as aluminum (Al), iron (Fe), or the like, or an alloy, and may be formed as a single layer or as a multilayer structure. The insulating layer 1220 may be made of a material having insulating characteristics, and may be formed of an inorganic or organic material. For example, the insulating layer 1220 may be made of an epoxy-based insulating resin, and in order to enhance thermal conductivity, the insulating layer 1220 may include a metal powder such as aluminum (Al) powder, or the like, so as to be used. The second metal layer 1230 may generally be formed as a copper (Cu) thin film.

As illustrated in FIG. 26, in the metal board, a distance, i.e., an insulation distance, of the exposed region of one end portion of the insulating layer 1220 may be greater than a thickness of the insulating layer 1220. In the present disclosure, the insulation distance refers to a distance of the exposed region of the insulating layer 1220 between the first metal layer 1210 and the second metal layer 1230. When the metal board is viewed from above, a width of the exposed region of the insulating layer 1220 is referred to as an exposure width W1. The region ‘R’ in FIG. 26 is a region removed through a grinding process, or the like, during a process of fabricating the metal board. An end portion of the metal board may have a depth ‘h’ corresponding to a distance from a surface of the second metal layer 1230 to the insulating layer 1220 where the insulating layer 1220 is exposed by the exposure width W1, forming a step structure. If the end portion of the metal board is not removed, an insulation distance corresponds to a thickness (h1+h2) of the insulating layer 1220, and by removing a portion of the end portion, the insulation distance approximately corresponding to a distance W1 may further be secured. Accordingly, in the case of conducting a withstand voltage experiment with respect to the metal board, the metal board having a structure in which contact possibility between the two metal layers 1210 and 1230 in the end portions thereof is minimized can be provided.

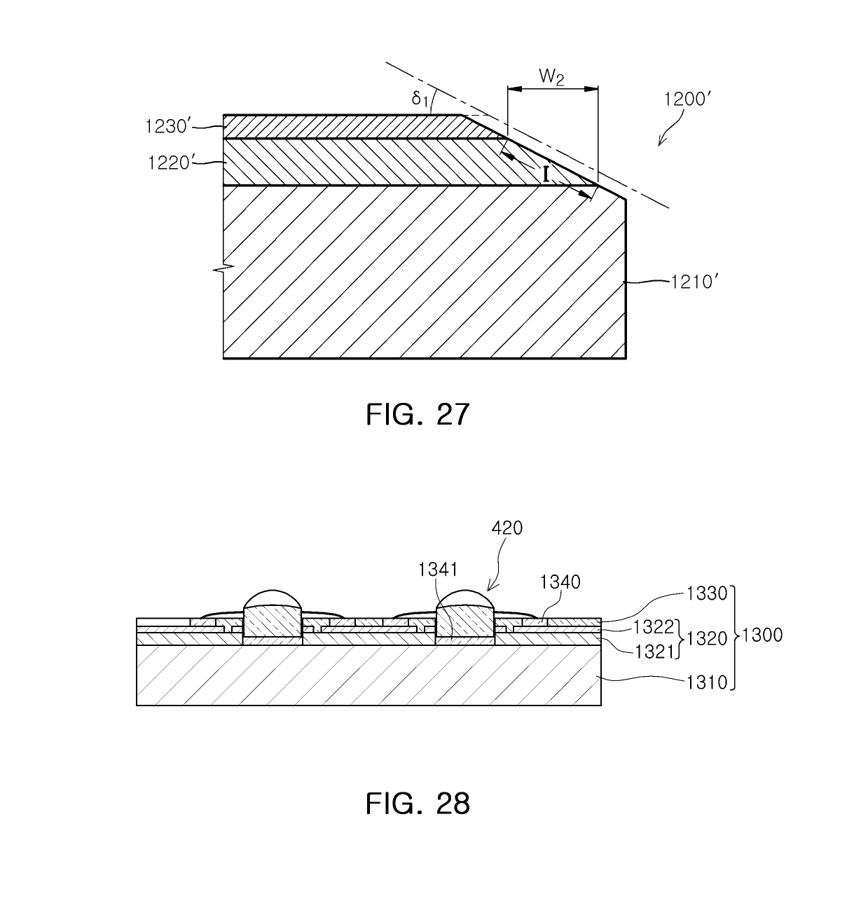

FIG. 27 schematically illustrates a structure of a metal board according to a modification of FIG. 26. Referring to FIG. 27, a metal board 1200′ includes an insulating layer 1220′ formed on a first metal layer 1210′ and a second metal layer 1230′ formed on the insulating layer 1220′. The insulating layer 1220′ and the second metal layer 1230′ include regions removed at a predetermined slope angle δ1, and even the first metal layer 1210′ may include a region removed at the predetermined slope angle δ1.

Here, the slope angle δ1 may be an angle between an interface between the insulating layer 1220′ and the second metal layer 1230′ and an end portion of the insulating layer 1220′, and may be selected to secure an insulation distance I in consideration of a thickness of the insulating layer 1220′. The slope angle δ1 may be selected within a range of 0<δ1<90 (degrees). As the slope angle δ1 is increased, the insulation distance I and a width W2 of the exposed region of the insulating layer 1220′ are increased. Thus, in order to secure a greater insulation distance, the slope angle δ1 may be selected to be small. For example, the slope angle δ1 may be selected to be within a range of 0<δ1≦45 (degrees).

FIG. 28 schematically illustrates another example of a board. Referring to FIG. 28, a board 1300 is formed by laminating a resin coated copper (RCC) film 1320, which includes an insulating layer 1321 and a copper foil 1322 laminated on the insulating layer 1321, on a metal support substrate 1310, and a portion of the RCC film 1320 may be removed to form at least one recess allowing the light emitting device 420 to be installed therein. In the metal board, because the RCC film 1320 is removed from a lower region of the light emitting device 420, the light emitting device 420 is in direct contact with the metal support substrate 1310, whereby heat generated by the light emitting device 420 is directly transmitted to the metal support substrate 1310, enhancing a heat radiation (or dissipation) performance thereof. The light emitting device 420 may be electrically connected or fixed through soldering (solders 1340 and 1341). A protective layer 1330 made of liquefied PSR may be formed on the copper foil 1322.

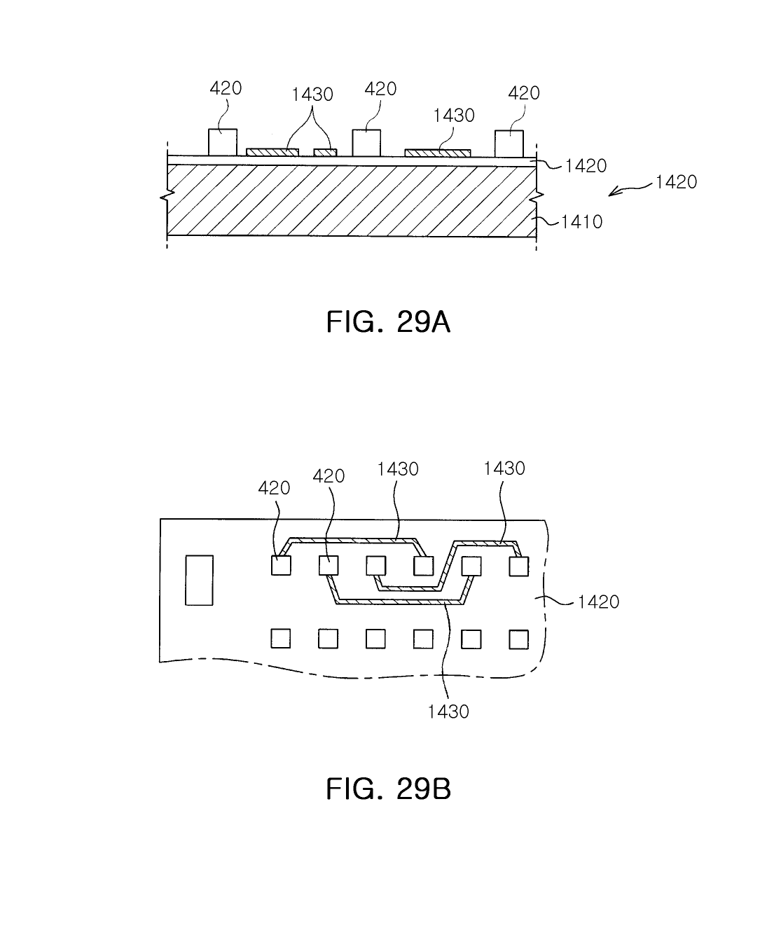

FIG. 29 schematically illustrates another example of a board. In this embodiment, the board includes an anodized metal board having excellent heat dissipation characteristics and incurring low manufacturing costs. Referring to FIG. 29, the anodized metal board 1400 may include a metal plate 1410, an anodized oxide film 1420 formed on the metal plate 1410, and electrical wirings 1430 formed on the anodized oxide film 1420.

The metal plate 1410 may be made of aluminum (Al) or an aluminum alloy that may be easily obtained at relatively low cost. Besides, the metal plate 1410 may be made of any other anodisable metal, for example, titanium, magnesium, or the like.

The aluminum anodized oxide film (Al2O3) 1420 obtained by anodizing aluminum has relatively high heat transmission characteristics ranging from approximately 10 to 30 W/mK. Thus, the anodized metal board has superior heat dissipation characteristics, relative to a printed circuit board (PCB), a metal core printed circuit board (MCPCB), or the like, of a conventional polymer board.

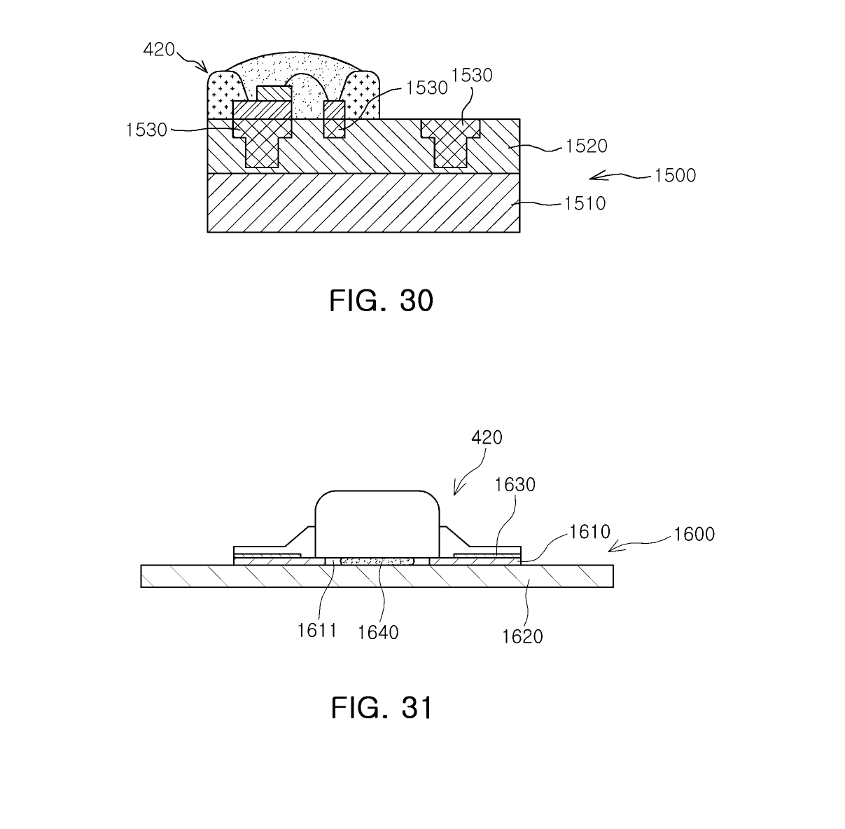

FIG. 30 schematically illustrates another example of a board. As illustrated in FIG. 30, a board 1500 may include an insulating resin 1520 coated on a metal substrate 1510 and a circuit pattern 1530 formed on the insulating resin 1520. Here, the insulating resin 1520 may have a thickness equal to or less than 200 μm. The insulating resin 1520 may be laminated as a solid film on the metal substrate 1510 or may be coated as a liquid according to a casting method using spin coating or a blade. Also, the circuit pattern 1530 may be formed by filling a design of a circuit pattern intagliated on the insulating resin 1520 with metal such as copper (Cu), or the like. The light emitting device 420 may be installed to be connected to the circuit pattern 1530.

Meanwhile, the board may include a flexible printed circuit board (FPCB) that is freely deformable. As illustrated in FIG. 31, a board 1600 may include an FPCB 1610 having one or more through holes 1611 and a support substrate 1620 on which the FPCB 1610 is mounted. A heat dissipation adhesive 1640 coupling a lower surface of the light emitting device 420 and an upper surface of the support substrate 1620 may be provided in the through hole 1611. Here, the lower surface of the light emitting device 420 may be a lower surface of a chip package, a lower surface of a lead frame with a chip mounted thereon, or a metal block. The FPCB 1610 includes a circuit wiring 1630, so it can be electrically connected to the light emitting device 420 thereby.

In this manner, by using the FPCB 1610, a thickness and a weight can be reduced, and manufacturing costs can be reduced. Also, because the light emitting device 420 is directly bonded to the support substrate 1620 by the heat dissipation adhesive 1640, enhancing heat dissipation efficiency, heat generated by the light emitting device 420 can be easily radiated.

The foregoing board may be formed to have a flat plate shape. However, a size and a structure of the board may be variously modified according to a structure of an apparatus in which the light source module according to the present exemplary embodiment, e.g., a lighting apparatus, is to be used.

A light emitting device may be mounted on the board and electrically connected thereto. Any photoelectric device may be used as the light emitting device 420 as long as it can generate light having a predetermined wavelength by power applied thereto from the outside, and typically, the light emitting device 420 may include a semiconductor light emitting diode (LED) in which a semiconductor layer is epitaxially grown on a growth substrate. The light emitting device 420 may emit blue, green, or red light according to a material contained therein, and may also emit white light.

For example, the light emitting device 420 may have a laminate structure including an n-type semiconductor layer and a p-type semiconductor layer and an active layer disposed there between. Also, here, the active layer may be formed of a nitride semiconductor including InxAlyGal-x-yN(0≦x≦1, 0≦y≦1, 0≦x+y≦1) having a single or multi-quantum well structure.

Meanwhile, the light emitting device employable in the lighting apparatus according to the forgoing embodiment may use LED chips having various structures or various types of LED packages including such LED chips. Hereinafter, various LED chips and LED packages employable in the lighting apparatuses according to exemplary embodiment will be described

### Light Emitting Device

### First Example

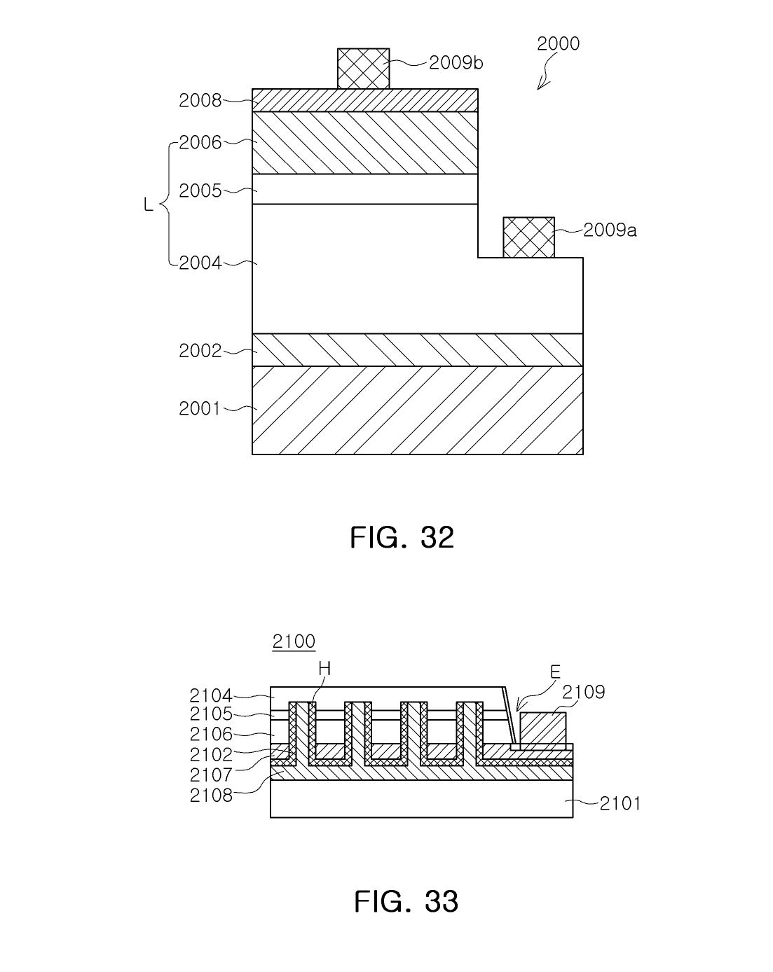

FIG. 32 is a side sectional view schematically illustrating an example of a light emitting device as a light emitting diode (LED) chip.

As illustrated in FIG. 32, a light emitting device 2000 may include a light emitting laminate L formed on a substrate 2001. The light emitting laminate L may include a first conductivity-type semiconductor layer 2004, an active layer 2005, and a second conductivity-type semiconductor layer 2006.

Also, an ohmic-contact layer 2008 may be formed on the second conductivity-type semiconductor layer 2006, and first and second electrodes 2009a and 2009b may be formed on upper surfaces of the first conductivity-type semiconductor layer 2004 and the ohmic-contact layer 2008, respectively.

In the present disclosure, terms such as ‘upper portion’, ‘upper surface’, ‘lower portion’, ‘lower surface’, ‘lateral surface’, and the like, are determined based on the drawings, and in actuality, the terms may be changed according to a direction in which a light emitting device is disposed.

Hereinafter, major components of a light emitting device will be described in detail.

[Substrate]

A substrate constituting a light emitting device is a growth substrate for epitaxial growth. As the substrate 2001, an insulating substrate, a conductive substrate, or a semiconductor substrate may be used. For example, the substrate 2001 may be made of sapphire, SiC, Si, MgAl2O4, MgO, LiAlO2, LiGaO2, GaN, or the like. In order to epitaxially grow a GaN material, a GaN substrate as a homogeneous substrate may be used, but a GaN substrate may incur high manufacturing costs due to difficulties in manufacturing thereof.

As a heterogeneous substrate, a sapphire substrate, a silicon carbide substrate, or the like, is commonly used, and in this case, a sapphire substrate is more frequently utilized, relative to a relatively expensive silicon carbide substrate. In the case of using a heterogeneous substrate, a defect such as dislocation, or the like, may be increased due to a difference between lattice constants of a substrate material and a thin film material. Also, due to a difference between coefficients of thermal expansion of a substrate material and a thin film material, warping may occur in the case of a temperature change, resulting in cracks in the thin film. This may be reduced by using a buffer layer 2002 formed between the substrate 2001 and the GaN-based light emitting laminate L.

In order to enhance light or electrical characteristics of the LED chip before or after the growth of the LED structure, the substrate 2001 may be fully or partially removed or patterned during a chip fabrication process.

For example, in the case of a sapphire substrate, the substrate may be separated by irradiating a laser onto an interface between the sapphire substrate and a semiconductor layer through the substrate, and in the case of a silicon substrate or a silicon carbide substrate, the substrate may be removed according to a method such as polishing/etching, or the like.

Also, in removing the substrate, a different support substrate may be used, and in this case, the support substrate may be attached to the opposite side of the original growth substrate by using a reflective metal or a reflective structure may be inserted into a middle portion of a bonding layer to enhance light efficiency of the LED chip.

In the case of substrate patterning, depressions and protrusions (or an uneven portion) or a sloped portion is formed on a main surface (one surface or both surfaces) of the substrate or on a lateral surface before or after the growth of the LED structure to thus enhance light extraction efficiency.

Referring to substrate patterning, an uneven surface or a sloped surface may be formed on a main surface (one surface or both surfaces) or a lateral surface of the substrate to enhance light extraction efficiency. A size of the pattern may be selected from within the range of 5 nm to 500 μm, and any pattern may be employed as long as it can enhance light extraction efficiency as a regular or an irregular pattern. The pattern may have various shapes such as a columnar shape, a peaked shape, a hemispherical shape, a polygonal shape, and the like.

In the case of a sapphire substrate, sapphire is a crystal having Hexa-Rhombo R3c symmetry, of which lattice constants in c-axis and a-axis directions are approximately 13.001 Å and 4.758 Å, respectively, and has a C-plane (0001), an A-plane (1120), an R-plane (1102), and the like. In this case, a nitride thin film may be relatively easily grown on the C-plane of the sapphire crystal, and because sapphire crystal is stable at high temperatures, the sapphire substrate is commonly used as a nitride growth substrate.

A silicon (Si) substrate may also be used. Because a silicon (Si) substrate is more appropriate for increasing a diameter and is relatively low in price, it may be used to facilitate mass-production. The Si substrate having a (111) plane as a substrate plane has a 17% difference in a lattice constant from that of GaN. Thus, a technique for suppressing a generation of a crystal defect due to the difference between lattice constants is required. Also, a difference between coefficients of thermal expansion of silicon and GaN is approximately 56%, for which, thus, a technique of suppressing warping of a wafer due to the difference between the coefficients of thermal expansion is required. A warped wafer may cause cracks in the GaN thin film and make it difficult to control a process, leading to an increase in a distribution of light emitting wavelengths in the same wafer, or the like.

The silicon (Si) substrate absorbs light generated in the GaN-based semiconductor to lower external quantum efficiency of the light emitting device. Thus, the substrate may be removed, and a support substrate such as an Si, Ge, SiAl, ceramic, or metal substrate, or the like, including a reflective layer, may be additionally formed to be used.

[Buffer Layer]

When a GaN thin film is grown on a heterogeneous substrate like the Si substrate, dislocation density may be increased due to a lattice constant mismatch between a substrate material and a thin film material, and cracks and warpage may be generated due to a difference between coefficients of thermal expansion.

In this case, in order to prevent dislocation of and cracks in the light emitting laminate L, a buffer layer 2002 may be disposed between the substrate 2001 and the light emitting laminate L. The buffer layer 2002 may serve to adjust a degree of warpage of the substrate when an active layer is grown, to reduce a wavelength distribution of a wafer.

The buffer layer may be made of AlxInyGal-x-yN (0≦x≦1, 0≦y≦1, 0≦x+y≦1), in particular, GaN, AlN, AlGaN, InGaN, or InGaNAlN, and a material such as ZrB2, HfB2, ZrN, HfN, TiN, or the like, may also be used. Also, the buffer layer may be formed by combining a plurality of layers or by gradually changing a composition.

The silicon substrate has a significant difference in the coefficient of thermal expansion from that of GaN. Thus, in the case of growing a GaN-based thin film on the silicon substrate, when the GaN thin film is grown at a high temperature and cooled at room temperature, tensile stress is applied to the GaN thin film due to the difference between the coefficients of thermal expansion of the substrate and the thin film, generating cracks. In order to prevent a generation of cracks, tensile stress is compensated for by using a method of growing the thin film such that compressive stress is applied to the thin film while being grown.

The difference between the lattice constants of silicon (Si) and GaN increases a possibility of a defect being generated in the silicon substrate. Thus, in the case of using a silicon substrate, a buffer layer having a composite structure may be used in order to control stress for restraining warpage as well as controlling a defect.

For example, first, an AlN layer is formed on the substrate 2001. In this case, a material not including gallium (Ga) may be used in order to prevent a reaction between silicon (Si) and gallium (Ga). Besides AlN, a material such as SiC, or the like, may also be used. The AlN layer is grown at a temperature ranging from 400° C. to 1,300° C. by using an aluminum (Al) source and a nitrogen (N) source. An AlGaN intermediate layer may be inserted into the middle of GaN between the plurality of AlN layers to control stress.

[Light Emitting Laminate]

The light emitting laminate L having a multilayer structure of a Group III nitride semiconductor will be described in detail. The first and second conductivity-type semiconductor layers 2004 and 2006 may be formed of n-type and p-type impurity-doped semiconductors, respectively.

However, all the exemplary embodiments are not limited thereto and, conversely, the first and second conductivity-type semiconductor layers 2004 and 2006 may be formed of p-type and n-type impurity-doped semiconductors. For example, the first and second conductivity-type semiconductor layers 2004 and 2006 may be made of a Group III nitride semiconductor, e.g., a material having a composition of AlxInyGal-x-yN (0≦x≦1, 0≦y≦1, 0≦x+y≦1). Of course, the exemplary embodiment is not limited thereto and the first and second conductivity-type semiconductor layers 2004 and 2006 may also be made of a material such as an AlGaInP-based semiconductor or an AlGaAs-based semiconductor.

Meanwhile, the first and second conductivity-type semiconductor layers 2004 and 2006 may have a unilayer structure, or, alternatively, the first and second conductivity-type semiconductor layers 2004 and 2006 may have a multilayer structure including layers having different compositions, thicknesses, and the like. For example, the first and second conductivity-type semiconductor layers 2004 and 2006 may have a carrier injection layer for improving electron and hole injection efficiency, or may have various types of superlattice structures, respectively.

The first conductivity-type semiconductor layer 2004 may further include a current diffusion layer in a region adjacent to the active layer 2005. The current diffusion layer may have a structure in which a plurality of InxAlyGa(1-x-y)N layers having different compositions or different impurity contents are successively laminated or may have an insulating material layer partially formed therein.

The second conductivity-type semiconductor layer 2006 may further include an electron blocking layer in a region adjacent to the active layer 2005. The electron blocking layer may have a structure in which a plurality of InxAlyGa(1-x-y)N layers having different compositions are laminated or may have one or more layers including AlyGa(1-y)N. The electron blocking layer has a bandgap wider than that of the active layer 2005, thus preventing electrons from being transferred over the second conductivity-type (p-type) semiconductor layer.

The light emitting laminate L may be formed by using metal-organic chemical vapor deposition (MOCVD). In order to fabricate the light emitting laminate L, an organic metal compound gas (e.g., trimethyl gallium (TMG), trimethyl aluminum (TMA)) and a nitrogen-containing gas (ammonia (NH3), or the like) are supplied to a reaction container in which the substrate 2001 is installed as reactive gases, the substrate is maintained at a high temperature ranging from 900° C. to 1,100° C., and while a gallium nitride-based compound semiconductor is being grown, an impurity gas is supplied to laminate the gallium nitride-based compound semiconductor as an undoped n-type or p-type semiconductor. Silicon (Si) is a well-known n-type impurity, and p-type impurities include zinc (Zn), cadmium (Cd), beryllium (Be), magnesium (Mg), calcium (Ca), barium (Ba), and the like. Among these, magnesium (Mg) and zinc (Zn) may mainly be used.

Also, the active layer 2005 disposed between the first and second conductivity-type semiconductor layers 2004 and 2006 may have a multi-quantum well (MQW) structure in which a quantum well layer and a quantum barrier layer are alternately laminated. For example, in the case of a nitride semiconductor, a GaN/InGaN structure may be used, or a single quantum well (SQW) structure may also be used.

[Ohmic-Contact Layer and First and Second Electrodes]

The ohmic-contact layer 2008 may have a relatively high impurity concentration to have low ohmic-contact resistance to lower an operating voltage of the element and enhance element characteristics. The ohmic-contact layer 2008 may be formed of a GaN layer, a InGaN layer, a ZnO layer, or a graphene layer.

The first or second electrode 2009a or 2009b may be made of a material such as silver (Ag), nickel (Ni), aluminum (Al), rhodium (Rh), palladium (Pd), iridium (Ir), ruthenium (Ru), magnesium (Mg), zinc (Zn), platinum (Pt), gold (Au), or the like, and may have a structure including two or more layers such as Ni/Ag, Zn/Ag, Ni/Al, Zn/Al, Pd/Ag, Pd/Al, Ir/Ag, Ir/Au, Pt/Ag, Pt/A1, Ni/Ag/Pt, or the like.

The LED chip illustrated in FIG. 32 has a structure in which first and second electrodes 2009a and 2009b face the same surface as a light extracting surface, but it may also be implemented to have various other structures, such as a flipchip structure in which first and second electrodes face a surface opposite to a light extracting surface, a vertical structure in which first and second electrodes are formed on mutually opposing surfaces, a vertical and horizontal structure employing an electrode structure by forming several vias in a chip as a structure for enhancing current spreading efficiency and heat dissipation efficiency, and the like.

### Light Emitting Device

### Second Example

In the case of manufacturing a large light emitting device for high output, an LED chip illustrated in FIG. 33 promoting current spreading efficiency and heat dissipation efficiency may be provided.

As illustrated in FIG. 33, an LED chip 2100 may include a first conductivity-type semiconductor layer 2104, an active layer 2105, a second conductivity-type semiconductor layer 2106, a second electrode layer 2107, an insulating layer 2102, a first electrode layer 2108 and a substrate 2101 sequentially laminated. Here, in order to be electrically connected to the first conductivity-type semiconductor layer 2104, the first electrode layer 2108 includes one or more contact holes H extending from one surface of the first electrode layer 2108 to at least a partial region of the first conductivity-type semiconductor layer 2104 and electrically insulated from the second conductivity-type semiconductor layer 2106 and the active layer 2105. However, the first electrode layer 2108 is not an essential element in the present embodiment.

The contact hole H extends from an interface of the first electrode layer 2108, passing through the second electrode layer 2107, the second conductivity-type semiconductor layer 2106, and the active layer 2105, to the interior of the first conductivity-type semiconductor layer 2104. The contact hole H extends to at least an interface between the active layer 2105 and the first conductivity-type semiconductor layer 2104, and may extend to a portion of the first conductivity-type semiconductor layer 2104. However, the contact hole H is formed for electrical connectivity and current spreading, so the purpose of the presence of the contact hole H is achieved when it is in contact with the first conductivity-type semiconductor layer 2104. Thus, it is not necessary for the contact hole H to extend to an external surface of the first conductivity-type semiconductor layer 2104.

The second electrode layer 2107 formed on the second conductivity-type semiconductor layer 2106 may be made of a material selected from among silver (Ag), nickel (Ni), aluminum (Al), rhodium (Rh), palladium (Pd), iridium (Ir), ruthenium (Ru), magnesium (Mg), zinc (Zn), platinum (Pt), gold (Au), and the like, in consideration of a light reflecting function and an ohmic-contact function with the second conductivity-type semiconductor layer 2106, and may be formed by using a process such as sputtering, deposition, or the like.

The contact hole H may have a form penetrating the second electrode layer 2107, the second conductivity-type semiconductor layer 2106, and the active layer 2105 so as to be connected to the first conductivity-type semiconductor layer 2104. The contact hole H may be formed through an etching process, e.g., inductively coupled plasma-reactive ion etching (ICP-RIE), or the like.

The insulating layer 2102 is formed to cover a side wall of the contact hole H and a surface of the second conductivity-type semiconductor layer 2106. In this case, at least a portion of the first conductivity-type semiconductor layer 2104 corresponding to the bottom of the contact hole H may be exposed. The insulating layer 2102 may be formed by depositing an insulating material such as SiO2, SiOxNy, or SixNy. The insulating layer 2102 may be deposited to have a thickness ranging from about 0.01 μm to 3 μm at a temperature equal to or lower than 500° C. through a chemical vapor deposition (CVD) process.

The first electrode layer 2108 including a conductive via formed by filling a conductive material is formed in the contact hole H. A plurality of conductive vias may be formed in a single light emitting device region. The amount of vias and contact areas thereof may be adjusted such that the area the plurality of vias occupy on the plane of the regions in which they are in contact with the second conductivity-type semiconductor layer 2104 ranges from 1% to 5% of the area of the light emitting device regions. A radius of the via on the plane of the region in which the via is in contact with the first conductivity-type semiconductor layer 2104 may range, for example, from 5 μm to 50 μm, and the number of vias may be 1 to 50 per light emitting device region according to a width of the light emitting region. Although different according to a width of the light emitting device region, three or more vias may be provided. A distance between the vias may range from 100 μm to 500 μm, and the vias may have a matrix structure including rows and columns. Further, the distance between vias may range from 150 μm to 450 μm. If the distance between the vias is smaller than 100 μm, the amount of vias may be relatively increased to reduce a light emitting area to lower luminous efficiency, and if the distance between the vias is greater than 500 μm, it may be difficult to spread a current to degrade luminous efficiency. A depth of the contact hole H may range from 0.5 μm to 5.0 μm although it may differ according to a thickness of the second conductivity-type semiconductor layer and the active layer.

Subsequently, the substrate 2101 is formed below the first electrode layer 2108. In this structure, the substrate 2101 may be electrically connected to the first conductivity-type semiconductor layer 2104 by a conductive via.

The substrate 2101 may be made of a material including any one of Au, Ni, Al, Cu, W, Si, Se, GaAs, SiAl, Ge, SiC, AlN, Al2O3, GaN, and AlGaN and may be formed through a process such as plating, sputtering, deposition, bonding, or the like. But all the exemplary embodiments are not limited thereto.

In order to reduce contact resistance, the amount, a shape, a pitch, a contact area with the first and second conductivity-type semiconductor layers 2104 and 2106, and the like, of the contact hole H may be appropriately regulated. The contact holes H may be arranged to have various shapes in rows and columns to improve a current flow. Here, the second electrode layer 2107 may have one or more exposed regions in the interface between the second electrode layer 2017 and the second conductivity-type semiconductor layer 2106, i.e., an exposed region E. An electrode pad unit 2109 connecting an external power source to the second electrode layer 2107 may be provided on the exposed region E.

In this manner, the LED chip 2100 illustrated in FIG. 33 may include the light emitting structure having the first and second main surfaces opposing one another and having the first and second conductivity-type semiconductor layers 2104 and 2106 providing the first and second main surfaces, respectively, and the active layer 2105 formed there between, the contact holes H connected to a region of the first conductivity-type semiconductor layer 2104 through the active layer 2105 from the second main surface, the first electrode layer 2108 formed on the second main surface of the light emitting structure and connected to a region of the first conductivity-type semiconductor layer 2104 through the contact holes H, and the second electrode layer 2107 formed on the second main surface of the light emitting structure and connected to the second conductivity-type semiconductor layer 2106. Here, any one of the first and second electrodes 2108 and 2107 may be drawn out in a lateral direction of the light emitting structure.

### Light Emitting Device

### Third Example

An LED lighting device provides improved heat dissipation characteristics, and in terms of overall heat dissipation performance, an LED chip having a low heating value is preferably used in a lighting device. As an LED chip satisfying such requirements, an LED chip including a nano-structure therein (hereinafter, referred to as a ‘nano-LED chip’) may be used.

Such a nano-LED chip includes a recently developed core/shell type nano-LED chip, which has a low binding density to generate a relatively low degree of heat, and has increased luminous efficiency by increasing a light emitting area by utilizing nano-structures, prevents a degradation of efficiency due to polarization by obtaining a non-polar active layer, thus improving drop characteristics such that luminous efficiency is reduced as an amount of injected current is increased.

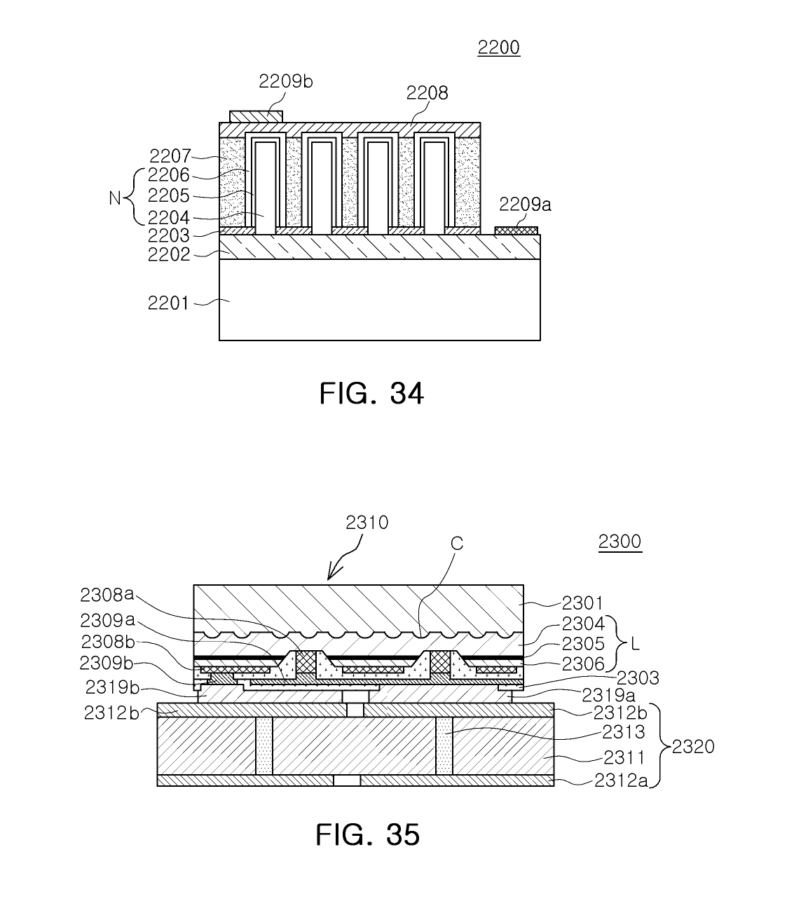

FIG. 34 illustrates a nano-LED chip as another example of an LED chip that may be employed in the foregoing lighting device.

As illustrated in FIG. 34, the nano-LED chip 2200 includes a plurality of nano-light emitting structures N formed on a substrate 2201. In this example, it is illustrated that the nano-light emitting structure N has a core-shell structure as a rod structure, but the exemplary embodiment is not limited thereto and the nano-light emitting structure N may have a different structure such as a pyramid structure.

The nano-LED chip 2200 includes a base layer 2202 formed on the substrate 2201. The base layer 2202 is a layer providing a growth surface for the nano-light emitting structure N, which may be a first conductivity-type semiconductor. A mask layer 2203 having an open area for the growth of the nano-light emitting structure N (in particular, the core) may be formed on the base layer 2202. The mask layer 2203 may be made of a dielectric material such as SiO2 or SiNx.

In the nano-light emitting structure N, a first conductivity-type nano core 2204 is formed by selectively growing a first conductivity-type semiconductor by using the mask layer 2203 having an open area, and an active layer 2205 and a second conductivity-type semiconductor layer 2206 are formed as shell layers on a surface of the nano core 2204. Accordingly, the nano-light emitting structure N may have a core-shell structure in which the first conductivity-type semiconductor is a nano core and the active layer 2205 and the second conductivity-type semiconductor layer 2206 enclosing the nano core are shell layers.

The nano-LED chip 2200 includes a filler material 2207 filling spaces between the nano-light emitting structures N. The filler material 2207 may be employed in order to structurally stabilize and optically improve the nano-light emitting structures N. The filler material 2207 may be made of a transparent material such as SiO2, but all the exemplary embodiments are not limited thereto. An ohmic-contact layer 2208 may be formed on the nano-light emitting structures N and connected to the second conductivity-type semiconductor layer 2206. The nano-LED chip 2200 includes the base layer 2202 formed of the first conductivity-type semiconductor and first and second electrodes 2209a and 2209b connected to the base layer 2202 and the ohmic-contact layer 1608, respectively.

By forming the nano-light emitting structures N such that they have different diameters, components, and doping densities, light having two or more different wavelengths may be emitted from the single element. By appropriately adjusting light having different wavelengths, white light may be implemented without using phosphors in the single element, and light having various colors or white light having different color temperatures may be implemented by combining a different LED chip to the foregoing element or combining wavelength conversion materials such as phosphors.

### Light Emitting Device

### Fourth Example

FIG. 35 illustrates a semiconductor light emitting device 2300 having an LED chip 2310 mounted on a mounting substrate 2320, as a light source that may be employed in the foregoing lighting device.

The semiconductor light emitting device 2300 illustrated in FIG. 35 includes the LED chip 2310. The LED chip 2310 is presented as an LED chip different from that of the example described above.

The LED chip 2310 includes a light emitting laminate L disposed on one surface of the substrate 2301 and first and second electrodes 2308a and 2308b disposed on the opposite side of the substrate 2301 based on the light emitting laminate L. Also, the LED chip 2310 includes an insulating layer 2303 covering the first and second electrodes 2308a and 2308b.

The first and second electrodes 2308a and 2308b may include first and second electrode pads 2319a and 2319b electrically connected thereto by electrical connection units 2309a and 2309b.

The light emitting laminate L may include a first conductivity-type semiconductor layer 2304, an active layer 2305, and a second conductivity-type semiconductor layer 2306 sequentially disposed on the substrate 2301. The first electrode 2308a may be provided as a conductive via connected to the first conductivity-type semiconductor layer 2304 through the second conductivity-type semiconductor layer 2306 and the active layer 2305. The second electrode 2308b may be connected to the second conductivity-type semiconductor layer 2306.

A plurality of conductive vias may be formed in a single light emitting device region. The amount of vias and contact areas thereof may be adjusted such that the area of the plurality of vias occupying on the plane of the regions in which they are in contact with the second conductivity-type semiconductor layer 2304 ranges from 1% to 5% of the area of the light emitting device regions. A radius of the via on the plane of the region in which the via is in contact with the first conductivity-type semiconductor layer 2304 may range, for example, from Sum to 50 μm, and the number of vias may be 1 to 50 per light emitting device region, according to a width of the light emitting region. Although different, according to a width of the light emitting device region, three or more vias may be provided. A distance between the vias may range from 100 μm to 500 μm, and the vias may have a matrix structure including rows and columns. Further, the distance between vias may range from 150 μm to 450 μm. If the distance between the vias is smaller than 100 μm, the amount of vias is increased to relatively reduce a light emitting area to lower luminous efficiency, and if the distance between the vias is greater than 500 μm, it may be difficult to spread a current to degrade luminous efficiency. A depth of the vias may range from 0.5 μm to 5.0 μm, although it may differ according to a thickness of the second conductivity-type semiconductor layer 2306 and the active layer 2305.

The first and second electrodes 2308a and 2308b are formed by depositing a conductive ohmic-material on the light emitting laminate L. The first and second electrodes 2308a and 2308b may include at least one of Ag, Al, Ni, Cr, Cu, Au, Pd, Pt, Sn, Ti, W, Rh, Ir, Ru, Mg, Zn, and alloys thereof. For example, the second electrode 2308b may be formed as a silver (Ag) ohmic-electrode layer laminated with regard to the second conductivity-type semiconductor layer 2306. The silver (Ag) ohmic-electrode layer may also serve as a light reflective layer. A single layer made of nickel (NI), titanium (Ti), platinum (Pt), tungsten (W), or a layer of alloys thereof may alternatively laminated selectively on the silver (Ag) layer. In detail, an Ni/Ti layer, a TiW/Pt layer, or a Ti/W layer may be laminated on the silver (Ag) layer or these layers may be alternately laminated on the silver (Ag) layer.

The first electrode 2308a may be formed by laminating a chromium (Cr) layer and sequentially laminating Au/Pt/Ti layers thereon with regard to the first conductivity-type semiconductor layer 2304, or may be formed by laminating an Al layer and sequentially laminating Ti/Ni/Au layers thereon with regard to the second conductivity-type semiconductor layer 2306. Besides the foregoing embodiment, the first and second electrodes 2308a and 2308b may employ various materials or lamination structures in order to enhance ohmic characteristics or reflective characteristics.

The insulating layer 2303 has an open area exposing at least portions of the first and second electrodes 2308a and 2308b, and the first and second electrode pads 2319a and 2319b may be connected to the first and second electrodes 2308a and 2308b. The insulating layer 2303 may be deposited to have a thickness ranging from 0.01 μm to 3 μm at a temperature equal to or lower than 500° C. through a CVD process.

The first and second electrodes 2308a and 2308b may be disposed in the same direction and may be mounted as a so-called flip-chip on a lead frame as described hereinafter.

In particular, the first electrode 2308a may be connected to the first electrical connection unit 2309a by a conductive via connected to the first conductivity-type semiconductor layer 2304 through the second conductivity-type semiconductor layer 2306 and the active layer 2305 within the light emitting laminate L.

The amount, a shape, a pitch, a contact area with the first conductivity-type semiconductor layer 2304, and the like, of the conductive via and the first electrical connection unit 2309a may be appropriately regulated in order to lower contact resistance, and the conductive via and the first electrical connection unit 2309a may be arranged in a row and in a column to improve current flow.

Another electrode structure may include the second electrode 2308b directly formed on the second conductivity-type semiconductor layer 2306 and the second electrical connection unit 2309b formed on the second electrode 2308b. In addition to having a function of forming electrical-ohmic connection with the second conductivity-type semiconductor layer 2306, the second electrode 2308b may be made of a light reflective material, whereby, as illustrated in FIG. 35, in a state in which the LED chip 2310 is mounted as a so-called flip chip structure, light emitted from the active layer 2305 can be effectively emitted in a direction of the substrate 2301. Of course, the second electrode 2308b may be made of a light-transmissive conductive material such as a transparent conductive oxide, according to a main light emitting direction.

The two electrode structures as described above may be electrically separated by the insulating layer 2303. The insulating layer 2303 may be made of any material as long as it has electrically insulating properties. Namely, the insulating layer 2303 may be made of any material having electrically insulating properties, and here, a material having a low degree of light absorption is used. For example, a silicon oxide or a silicon nitride such as SiO2, SiOxNy, SixNy, or the like, may be used. A light reflective filler may be dispersed in the light-transmissive material to form a light reflective structure.

The first and second electrode pads 2319a and 2319b may be connected to the first and second electrical connection units 2309a and 2309b to serve as external terminals of the LED chip 2310, respectively. For example, the first and second electrode pads 2319a and 2319b may be made of gold (Au), silver (Ag), aluminum (Al), titanium (Ti), tungsten (W), copper (Cu), tin (Sn), nickel (Ni), platinum (Pt), chromium (Cr), NiSn, TiW, AuSn, or a eutectic metal thereof. In this case, when the LED chip 2310 is mounted on the mounting substrate 2320, the first and second electrode pads 2319a and 2319b may be bonded by using the eutectic metal, so solder bumps generally required for flip chip bonding may not be used. The use of a eutectic metal advantageously obtains superior heat dissipation effects in the mounting method as compared to the case of using solder bumps. In this case, in order to obtain excellent heat dissipation effects, the first and second electrode pads 2319a and 2319b may be formed to occupy a relatively large area.

The substrate 2301 and the light emitting laminate L may be understood with reference to content described above with reference to FIG. 32 unless otherwise described. Also, although not shown, a buffer layer may be formed between the light emitting laminate L and the substrate 2301. The buffer layer may be employed as an undoped semiconductor layer made of a nitride, or the like, to alleviate lattice defects of the light emitting laminate L grown thereon.

The substrate 2301 may have first and second main surfaces opposing one another, and an uneven structure C (i.e., depressions and protrusions) may be formed on at least one of the first and second main surfaces. The uneven structure C formed on one surface of the substrate 2301 may be formed by etching a portion of the substrate 2301 so as to be made of the same material as that of the substrate. Alternatively, the uneven structure C may be made of a heterogeneous material different from that of the substrate 2301.

In the exemplary embodiment, because the uneven structure C is formed on the interface between the substrate 2301 and the first conductivity-type semiconductor layer 2304, the paths of light emitted from the active layer 2305 may be widely varied, and thus, a light absorption ratio of light absorbed within the semiconductor layer can be reduced and a light scattering ratio can be increased, increasing light extraction efficiency.

In detail, the uneven structure C may be formed to have a regular or irregular shape. The heterogeneous material used to form the uneven structure C may be a transparent conductor, a transparent insulator, or a material having excellent reflectivity. Here, as the transparent insulator, a material such as SiO2, SiNx, Al2O3, HfO, TiO2, or ZrO may be used.

As the transparent conductor, a transparent conductive oxide (TCO) such as ZnO, an indium oxide containing an additive (e.g., Mg, Ag, Zn, Sc, Hf, Zr, Te, Se, Ta, W, Nb, Cu, Si, Ni, Co, Mo, Cr, Sn), or the like, may be used. As the reflective material, silver (Ag), aluminum (Al), or a distributed Bragg reflector (DBR) including multiple layers having different refractive indices, may be used. However, the exemplary embodiment is not limited thereto.

The substrate 2301 may be removed from the first conductivity-type semiconductor layer 2304. To remove the substrate 2301, a laser lift-off (LLO) process using a laser, an etching or a polishing process may be used. Also, after the substrate 2301 is removed, depressions and protrusions may be formed on the surface of the first conductivity-type semiconductor layer 2304.

As illustrated in FIG. 35, the LED chip 2310 is mounted on the mounting substrate 2320. The mounting substrate 2320 includes a first upper electrode layer 2312a, a first lower electrode layer 2312b, a second upper electrode layer 2313a and a second lower electrode layer 2313b formed on upper and lower surfaces of the substrate body 2311, and vias 2313 penetrating the substrate body 2311 to connect the upper and lower electrode layers. The substrate body 2311 may be made of a resin, a ceramic, or a metal, and the upper and lower electrode layers 2312a, 2313a, 2312b and 2313b may be a metal layer made of gold (Au), copper (Cu), silver (Ag), or aluminum (Al).

Of course, the substrate on which the foregoing LED chip 2310 is mounted is not limited to the configuration of the mounting substrate 2320 illustrated in FIG. 35, and any substrate having a wiring structure for driving the LED chip 2310 may be employed. For example, the substrate may be any one of the substrates of FIGS. 25 through 31, and may be provided as a package structure in which an LED chip is mounted on a package body having a pair of lead frames.

### Other Examples of Light Emitting Device

LED chips having various structures other than that of the foregoing LED chip described above may also be used. For example, an LED chip in which surface-plasmon polaritons (SPP) are formed in a metal-dielectric boundary of an LED chip to interact with quantum well excitons, thus obtaining significantly improved light extraction efficiency, may also be advantageously used.

Meanwhile, the light emitting device 420 may be configured to include at least one of a light emitting device emitting white light by combining green, red, and orange phosphors with a blue LED chip and a purple, blue, green, red, and infrared light emitting device. In this case, the light emitting device 420 may have a color rendering index (CRI) adjusted to range from a sodium-vapor lamp (color rending index: 40) to a sunlight level (color rendering index: 100), or the like, and have a color temperature ranging from about 2000K to 20000K level to generate various types of white light. The light emitting device 420 may generate visible light having purple, blue, green, red, orange colors, or infrared light to adjust an illumination color according to a surrounding atmosphere or mood. Also, the light source apparatus may generate light having a special wavelength stimulating plant growth.

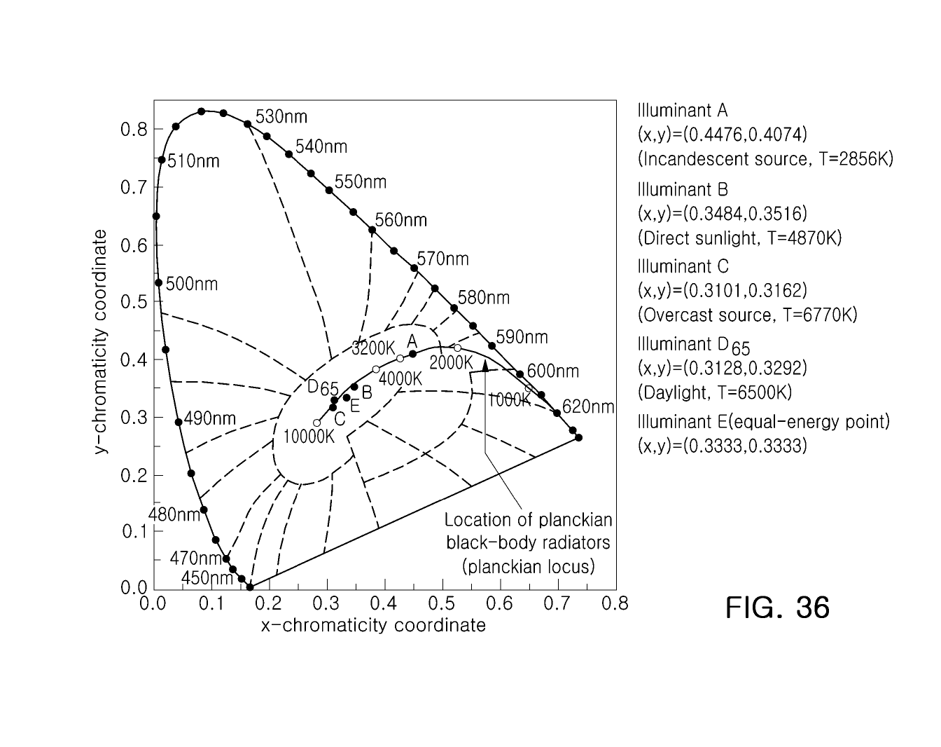

White light generated by applying yellow, green, red phosphors to a blue LED chip and combining at least one of green and red LEDs thereto may have two or more peak wavelengths and may be positioned in a segment linking (x,y) coordinates (0.4476, 0.4074), (0.3484, 0.3516), (0.3101, 0.3162), (0.3128, 0.3292), (0.3333, 0.3333) of a CIE 1931 chromaticity diagram illustrated in FIG. 36. Alternatively, white light may be positioned in a region surrounded by a spectrum of black body radiation and the segment. A color temperature of white light corresponds to a range from 2000K to 20000K.

Phosphors may have the following empirical formula and colors.

Oxide system: Yellow and green Y3Al5012:Ce, Tb3Al5O12:Ce, Lu3Al5O12:Ce

Silicate system: Yellow and green (Ba,Sr)2SiO4:Eu, yellow and orange (Ba,Sr)3SiO5:Ce

Nitride system: Green β-SiAlON:Eu, yellow L3Si6O11:Ce, orange α-SiAlON:Eu, red CaAlSiN3:Eu, Sr2Si5N8:Eu, SrSiAl4N7:Eu

Fluoride system: KSF system red K2SiF6:Mn4+

Phosphor compositions should be basically conformed with Stoichiometry, and respective elements may be substituted with different elements of respective groups of the periodic table. For example, strontium (Sr) may be substituted with barium (Ba), calcium (Ca), magnesium (Mg), or the like, of alkali earths, and yttrium (Y) may be substituted with terbium (Tb), Lutetium (Lu), scandium (Sc), gadolinium (Gd), or the like. Also, europium (Eu), an activator, may be substituted with cerium (Ce), terbium (Tb), praseodymium (Pr), erbium (Er), ytterbium (Yb), or the like, according to an energy level, and an activator may be applied alone or a coactivator, or the like, may be additionally applied to change characteristics.

Also, materials such as quantum dots, or the like, may be applied as materials that replace phosphors, and phosphors and quantum dots may be used in combination or alone in an LED.

A quantum dot may have a structure including a core (3 to 10 nm) such as CdSe, InP, or the like, a shell (0.5 to 2 nm) such as ZnS, ZnSe, or the like, and a ligand for stabilizing the core and the shell, and may implement various colors according to sizes.

Table 1 below shows types of phosphors in applications fields of white light emitting devices using a blue LED (440 nm to 460 nm).

TABLE 1

| Purpose | Phosphors |
|---|---|
| LED TV BLU | β-SiAlON:Eu2+ |
| | (Ca,Sr)AlSiN3:Eu2+ |
| | L3Si6O11:Ce3+ |
| | K2SiF6:Mn4+ |
| Lighting | Lu3Al5O12:Ce3+ |
| | Ca-α-SiAlON:Eu2+ |
| | L3Si6N11:Ce3+ |
| | (Ca,Sr)AlSiN3:Eu2+ |
| | Y3Al5O12:Ce3+ |
| | K2SiF6:Mn4+ |
| Side View | Lu3Al5O12:Ce3+ |
| (Mobile, Note PC) | Ca-α-SiAlON:Eu2+ |
| | L3Si6N11:Ce3+ |
| | (Ca,Sr)AlSiN3:Eu2+ |
| | Y3Al5O12:Ce3+ |
| | (Sr,Ba,Ca,Mg)2SiO4:Eu2+ |
| | K2SiF6:Mn4+ |
| Electrical component | Lu3Al5O12:Ce3+ |
| (Head Lamp, etc.) | Ca-α-SiAlON:Eu2+ |
| | L3Si6N11:Ce3+ |
| | (Ca,Sr)AlSiN3:Eu2+ |
| | Y3Al5O12:Ce3+ |
| | K2SiF6:Mn4+ |

Phosphors or quantum dots may be applied by using at least one of a method of spraying them on a light emitting device, a method of covering as a film, and a method of attaching as a sheet of ceramic phosphor, or the like.

As the spraying method, dispensing, spray coating, or the like, is generally used, and dispensing includes a pneumatic method and a mechanical method such as a screw fastening scheme, a linear type fastening scheme, or the like. Through a jetting method, an amount of dotting may be controlled through a very small amount of discharging and color coordinates (or chromaticity) may be controlled there through. In the case of a method of collectively applying phosphors on a wafer level or on a mounting board on which an LED is mounted, productivity can be enhanced and a thickness can be easily controlled.

The method of directly covering a light emitting device with phosphors or quantum dots as a film may include electrophoresis, screen printing, or a phosphor molding method, and these methods may have a difference according to whether a lateral surface of a chip is required to be coated or not.

Meanwhile, in order to control efficiency of a long wavelength light emitting phosphor re-absorbing light emitted in a short wavelength, among two types of phosphors having different light emitting wavelengths, two types of phosphor layer having different light emitting wavelengths may be provided, and in order to minimize re-absorption and interference of chips and two or more wavelengths, a DBR (ODR) layer may be included between respective layers. In order to form a uniformly coated film, after a phosphor is fabricated as a film or a ceramic form and attached to a chip or a light emitting device.

In order to differentiate light efficiency and light distribution characteristics, a light conversion material may be positioned in a remote form, and in this case, the light conversion material may be positioned together with a material such as a light-transmissive polymer, glass, or the like, according to durability and heat resistance.

A phosphor applying technique plays the most important role in determining light characteristics in an LED device, so techniques of controlling a thickness of a phosphor application layer, a uniform phosphor distribution, and the like, have been variously researched.

A quantum dot (QD) may also be positioned in a light emitting device in the same manner as that of a phosphor, and may be positioned in glass or a light-transmissive polymer material to perform optical conversion.

In the present exemplary embodiment, the light emitting device is illustrated as being a single package unit including an LED chip therein, but all exemplary embodiments are not limited thereto. For example, the light emitting device 120 may be an LED chip itself. In this case, the LED chip may be a COB type chip and may be mounted on the board and directly electrically connected to the board through a flip chip bonding method or a wire bonding method.

Also, a plurality of light emitting devices may be arranged on the board. In this case, the light emitting devices may be the same type of light emitting devices generating light having the same wavelength or may be various types of light emitting devices generating different wavelengths of light. In the present exemplary embodiment, it is illustrated that a plurality of light emitting devices are arranged, but all exemplary embodiments are not limited thereto and a single light emitting device may be provided.

The lighting apparatus using the LED as described above may be classified as an indoor lighting apparatus and an outdoor lighting apparatus according to the purpose thereof. The indoor LED lighting apparatus may include a lamp, a fluorescent lamp (LED-tube), a flat panel type lighting apparatus replacing an existing lighting fixture (retrofit), and the outdoor LED lighting apparatus may include a streetlight, a security light, a flood light, a scene lamp, a traffic light, and the like.

Also, the lighting apparatus using the LED may be utilized as an internal or external light source of a vehicle. As an internal light source, the lighting apparatus using the LED may be used as an indoor light of a vehicle, a reading light, or as various dashboard light sources. As an external light source, the lighting apparatus using the LED may be used as for a light source in vehicle lighting fixture such as a headlight, a brake light, a turn signal lamp, a fog light, a running light, and the like.

In addition, the LED lighting apparatus may also be applicable as a light source used in robots or various mechanic facilities. In particular, LED lighting using a particular wavelength band may accelerate plant growth, and stabilize a user's mood or treat a disease using sensitivity (or emotional) illumination (or lighting).

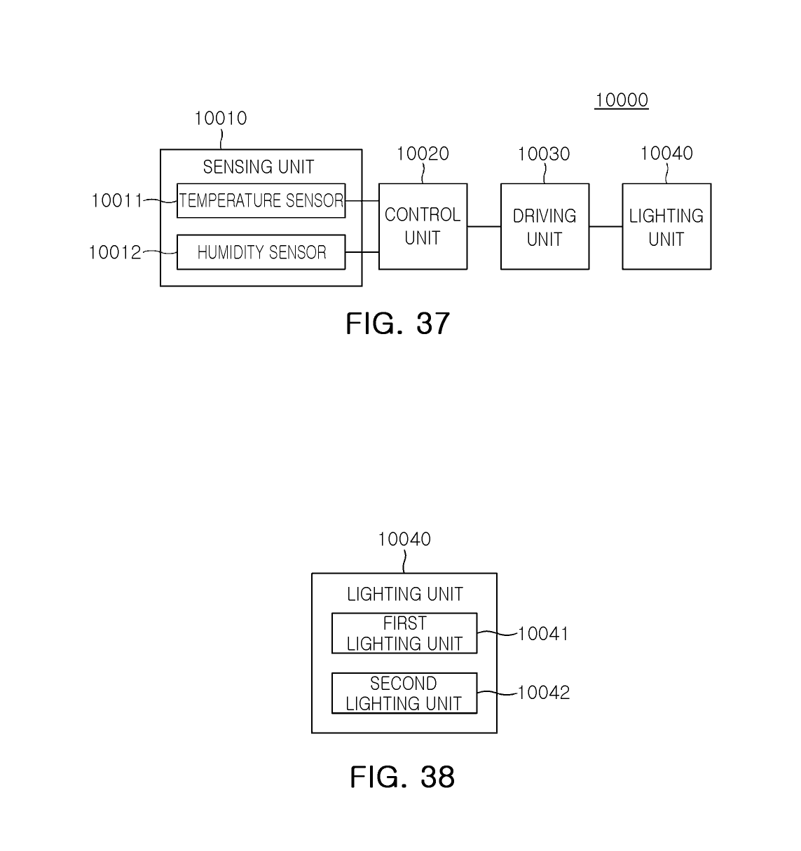

A lighting system using the lighting device as described above with reference to FIGS. 37 to 40 will be described. The lighting system according to the present embodiment may be able to provide a lighting device having sensitivity (or emotional) illumination that is able to automatically adjust a color temperature according to a surrounding environment (e.g., temperature and humidity conditions) and to suit human needs, rather than serving as a simple illumination device.

FIG. 37 is a block diagram schematically illustrating a lighting system according to an embodiment of the present disclosure.

Referring to FIG. 37, a lighting system 10000 according to an embodiment of the present disclosure may include a sensing unit 10010, a control unit 10020, a driving unit 10030, and a lighting unit 10040.

The sensing unit 10010 may be installed in an indoor or outdoor area, and may have a temperature sensor 10011 and a humidity sensor 10012 to measure at least one air condition among ambient temperature and humidity. The sensing unit 10010 transmits the measured at least one air condition, i.e., at least one of temperature and humidity, to the control unit 10020 electrically connected thereto.

The control unit 10020 may compare the temperature and humidity of the measured air with air condition settings (a temperature and a humidity range) previously set by a user, and determine a color temperature of the lighting unit 10040 corresponding to the air condition according to the comparison results. The control unit 10020 is electrically connected to the driving unit 10030, and controls the driving unit 10030 to drive the lighting unit 10040.

The lighting unit 10040 operates according to power supplied by the driving unit 1003. The lighting unit 10040 may include at least one lighting device illustrated in FIGS. 1, 8 and 15. For example, as illustrated in FIG. 38, the lighting unit 10040 may include a first lighting device 10041 and a second lighting device 10042 having different color temperatures, and each of the lighting devices 10041 and 10042 may include a plurality of light emitting devices emitting the same white light.

The first lighting device 10041 may emit white light having a first color temperature, and the second lighting device 10042 may emit white light having a second color temperature. In this case, the first color temperature may be lower than the second color temperature. Conversely, the first color temperature may be higher than the second color temperature. Here, white light having a relatively low color temperature corresponds to warm white light, and white light having a relatively high color temperature corresponds to cold white light. When power is supplied to the first and second lighting devices 10041 and 10042, the first and second lighting devices 10041 and 10042 emit white light having a first color temperature and a second color temperature, respectively, and the respective white light beams are mixed to implement white light having a color temperature determined by the control unit 10020.

In detail, in a case in which the first color temperature is lower than the second color temperature, if a color temperature determined by the control unit 10020 is relatively high, a quantity of light of the first lighting device 10041 may be reduced and that of the second lighting device 10042 may be increased to implement mixed white light having the predetermined color temperature. Conversely, when the predetermined color temperature is relatively low, a quantity of the first lighting device 10041 may be increased and that of the second lighting device 10042 may be reduced to implement mixed white light having the predetermined color temperature. Here, the quantity of light of the respective lighting devices 10041 and 10042 may be implemented by adjusting a quantity of light of the entire light emitting devices by regulating power, or may be implemented by adjusting the amount of light emitting devices driven.

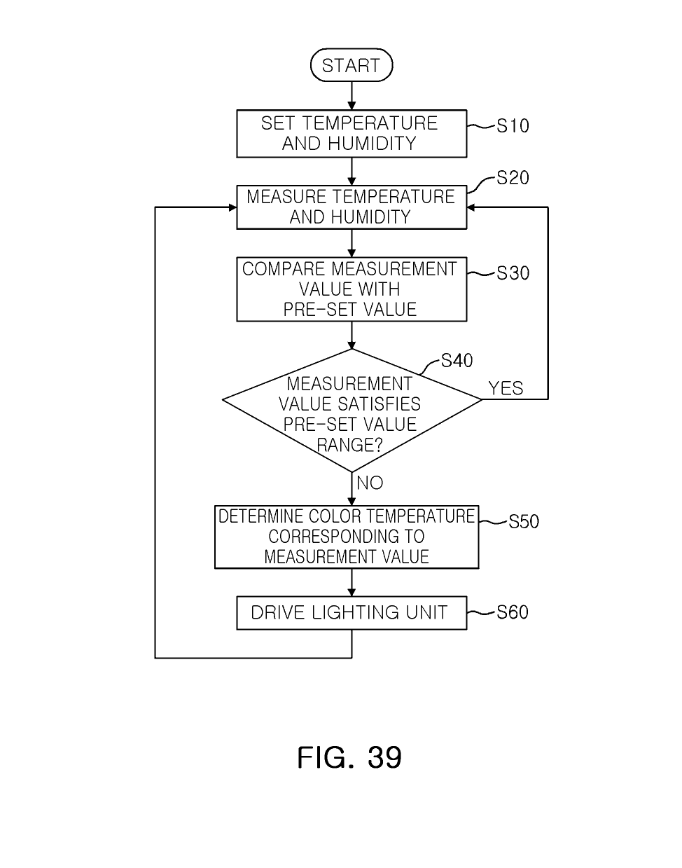

FIG. 39 is a flow chart illustrating a method for controlling the lighting system illustrated in FIG. 37. Referring to FIG. 39, first, a user sets a color temperature according to a temperature and humidity range through the control unit 10020 (S 10). The set temperature and humidity data is stored in the control unit 10020.

In general, when a color temperature is equal to or more than 6000K, a color providing a cool feeling, such as blue, may be produced, and when a color temperature is less than 4000K, a color providing a warm feeling, such as red, may be produced. Thus, in the present embodiment, when a temperature and humidity exceed 20° C. and 60%, respectively, the user may set the lighting unit 10040 to be turned on to have a color temperature higher than 6000K through the control unit 10020, when a temperature and humidity range from 10° C. to 20° C. and 40% to 60%, respectively, the user may set the lighting unit 10040 to be turned on to have a color temperature ranging from 4000K to 6000K through the control unit 10020, and when a temperature and humidity are lower than 10° C. and 40%, respectively, the user may set the lighting unit 10040 to be turned on to have a color temperature lower than 4000K through the control unit 10020.

Next, the sensing unit 10010 measures at least one condition among ambient temperature and humidity (S20). The temperature and humidity measured by the sensing unit 10010 are transmitted to the control unit 10020.

Subsequently, the control unit 10020 compares the measurement values transmitted from the sensing unit 10010 with pre-set values (S30). Here, the measurement values are temperature and humidity data measured by the sensing unit 10010 and the pre-set values are temperature and humidity values previous set by the user and stored in the control unit 10020. Namely, the control unit 10020 compares the measured temperature and humidity levels with pre-set temperature and humidity levels.

The control unit 10020 determines whether the measurement values satisfy pre-set value ranges (S40). When the measurement values satisfy the pre-set value ranges, the control unit 10020 maintains a current color temperature, and continues to measure temperature and humidity (S20). Meanwhile, when the measurement values do not satisfy the pre-set value ranges, the control unit 10020 detects pre-set values corresponding to the measurement values and determines a corresponding color temperature (S50). Thereafter, the control unit 10020 controls the driving unit 10030 to drive the lighting unit 10040 to have the predetermined color temperature.

Then, the driving unit 10030 drives the lighting unit 10040 to have the predetermined color temperature (S60). Namely, the driving unit 10030 supplies required power to drive the lighting unit 10040 to implement the predetermined color temperature. Accordingly, the lighting unit 10040 may be adjusted to have a color temperature corresponding to the temperature and humidity previously set by the user according to ambient temperature and humidity.

In this manner, the lighting system is able to automatically regulate a color temperature of the indoor lighting unit according to changes in ambient temperature and humidity, thereby satisfying human moods varied according to changes in the surrounding natural environment and providing psychological stability.

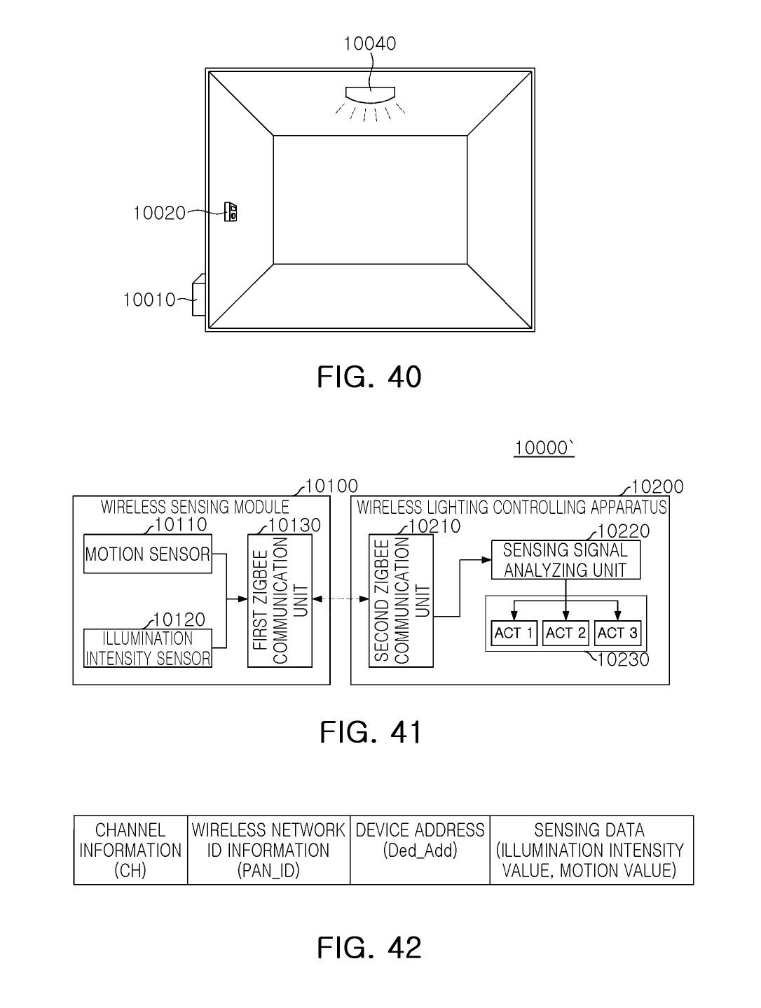

FIG. 40 is a view schematically illustrating the use of the lighting system illustrated in FIG. 37. As illustrated in FIG. 40, the lighting unit 10040 may be installed on the ceiling as an indoor lamp. Here, the sensing unit 10010 may be implemented as a separate device and installed on an outer wall in order to measure outdoor temperature and humidity. The control unit 10020 may be installed in an indoor area to allow the user to easily perform setting and ascertainment operations. However, the lighting system according to an exemplary embodiment is not limited thereto and may be installed on the wall in the place of an interior illumination device or may be applicable to a lamp, such as a desk lamp, or the like, that can be used in indoor and outdoor areas.

Another example of a lighting system using the foregoing lighting device will be described with reference to FIGS. 41 through 44. The lighting system according to the present embodiment may automatically perform a predetermined control by detecting a motion of a monitored target and an intensity of illumination at a location of the monitored target and automatically perform the predetermined control.

FIG. 41 is a block diagram of a lighting system according to another exemplary embodiment.

Referring to FIG. 41, a lighting system 10000′ according to the present embodiment includes a wireless sensing module 10100 and a wireless lighting controlling apparatus 10200.

The wireless sensing module 10100 may include a motion sensor 10100, an illumination intensity sensor 10120 sensing an intensity of illumination, and a first wireless communications unit generating a wireless signal that includes a motion sensing signal from the motion sensor 10110 and an illumination intensity sensing signal from the illumination intensity sensor 10120 and that complies with a predetermined communications protocol, and transmitting the same. The first wireless communications unit may be configured as a first ZigBee communications unit 10130 generating a ZigBee signal that complies with a pre-set communications protocol and transmitting the same.

The wireless lighting controlling apparatus 10200 may include a second wireless communications unit receiving a wireless signal from the first wireless communications unit and restoring a sensing signal, a sensing signal analyzing unit 10220 analyzing the sensing signal from the second wireless communications unit, and an operation control unit 10230 performing a predetermined control based on analysis results from the sensing signal analyzing unit 10220. The second wireless communications unit may be configured as a second ZigBee communications unit 10210 receiving a ZigBee signal from the first ZigBee communications unit and restoring a sensing signal.

FIG. 42 is a view illustrating a format of a ZigBee signal according to an exemplary embodiment.

Referring to FIG. 33, the ZigBee signal from the first ZigBee communications unit 10130 may include channel information (CH) defining a communications channel, a wireless network identification (ID) information (PAN_ID) defining a wireless network, a device address (Ded_Add) designating a target device, and sensing data including the motion and illumination intensity signal.

Also, the ZigBee signal from the second ZigBee communications unit 10210 may include channel information (CH) defining a communications channel, a wireless network identification (ID) information (PAN_ID) defining a wireless network, a device address (Ded_Add) designating a target device, and sensing data including the motion and illumination intensity signal.

The sensing signal analyzing unit 10220 may analyze the sensing signal from the second ZigBee communications unit 10210 to detect a satisfied condition, among a plurality of conditions, based on the sensed motion and the sensed intensity of illumination.

Here, the operation control unit 10230 may set a plurality of controls based on a plurality of conditions that are previously set by the sensing signal analyzing unit 10220, and perform a control corresponding to the condition detected by the sensing signal analyzing unit 10220.

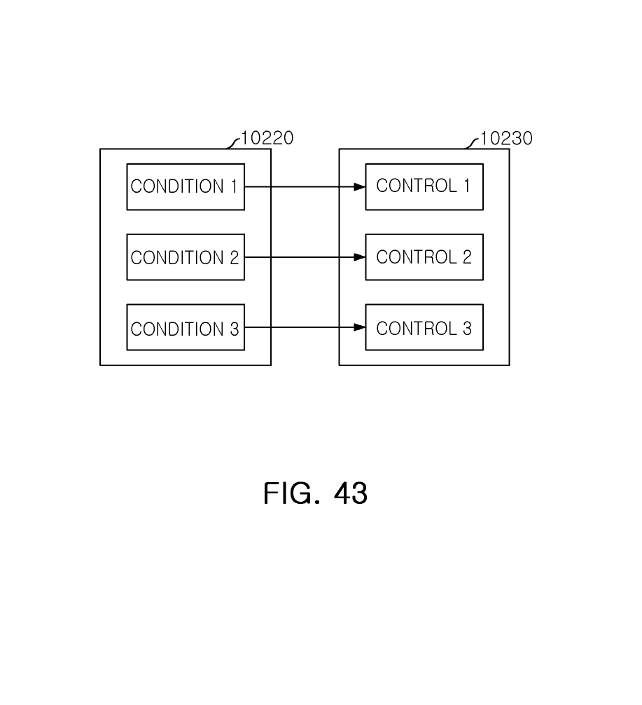

FIG. 43 is a view illustrating the sensing signal analyzing unit and the operation control unit according to an exemplary embodiment. Referring to FIG. 43, for example, the sensing signal analyzing unit 10220 may analyze the sensing signal from the second ZigBee communications unit 10210 and detect a satisfied condition among first, second, and third conditions (condition 1, condition 2, and condition 3), based on the sensed motion and sensed intensity of illumination.

In this case, the operation control unit 10230 may set first, second and third controls (control 1, control 2, and control 3) corresponding to the first, second, and third conditions (condition 1, condition 2, and condition 3) previously set by the sensing signal analyzing unit 10220, and perform a control corresponding to the condition detected by the sensing signal analyzing unit 10220.

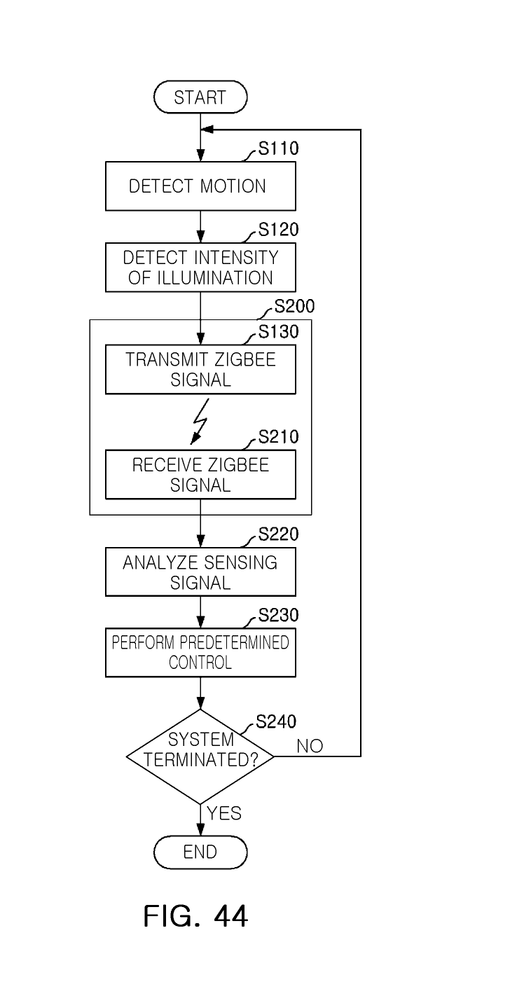

FIG. 44 is a flow chart illustrating an operation of a wireless lighting system according to an exemplary embodiment.

In FIG. 44, in operation S110, the motion sensor 10110 detects a motion. In operation S120, the illumination intensity sensor 10120 detects an intensity of illumination. Operation S200 is a process of transmitting and receiving a ZigBee signal. Operation 5200 may include operation S130 of transmitting a ZigBee signal by the first ZigBee communications unit 10130 and operation S210 of receiving the ZigBee signal by the second ZigBee communications unit 10210. In operation S220, the sensing signal analyzing unit 10220 analyzes a sensing signal. In operation S230, the operation control unit 10230 performs a predetermined control. In operation S240, whether the lighting system is terminated is determined.

Operations of the wireless sensing module and the wireless lighting controlling apparatus according to an exemplary embodiment will be described with reference to FIGS. 41 through 44.

First, the wireless sensing module 10100 of the wireless lighting system according to an exemplary embodiment will be described with reference to FIGS. 41, 42, and 44. The wireless lighting system 10100 according to an exemplary embodiment is installed in a location in which a lighting device is installed, to detect a current intensity of illumination of the current of the lighting device and detect human motion near the lighting device.

Namely, the motion sensor 10110 of the wireless sensing module 10100 is configured as an infrared sensor, or the like, capable of sensing a human. The motion sensor 10100 senses a motion and provides the same to the first ZigBee communications unit 10130 (S110 in FIG. 44). The illumination intensity sensor 10120 of the wireless sensing module 10100 senses an intensity of illumination and provides the same to the first ZigBee communications unit 10130 (S120).

Accordingly, the first ZigBee communications unit 10130 generates a ZigBee signal that includes the motion sensing signal from the motion sensor 10100 and the illumination intensity sensing signal from the illumination intensity sensor 10120 and that complies with a pre-set communications protocol, and transmits the generated ZigBee signal wirelessly (S130).

Referring to FIG. 42, the ZigBee signal from the first ZigBee communications unit 10130 may include channel information (CH) defining a communications channel, a wireless network identification (ID) information (PAN_ID) defining a wireless network, a device address (Ded_Add) designating a target device, and sensing data, and here, the sensing data includes a motion value and an illumination intensity value.

Next, the wireless lighting controlling apparatus 10200 of the wireless lighting system according to an exemplary embodiment will be described with reference to FIGS. 41 through 44. The wireless lighting controlling apparatus 10200 of the wireless lighting system according to an exemplary embodiment may control a predetermined operation according to an illumination intensity value and a motion value included in a ZigBee signal from the wireless sensing module 10100.

Namely, the second ZigBee communications unit 10210 of the wireless lighting controlling apparatus 10200 according to an exemplary embodiment receives a ZigBee signal from the first ZigBee communications unit 10130, restores a sensing signal therefrom, and provides the restored sensing signal to the sensing signal analyzing unit 10200 (S210 in FIG. 44).

Referring to FIG. 42, the ZigBee signal from the second ZigBee communications unit 10210 may include channel information (CH) defining a communications channel, a wireless network identification (ID) information (PAN_ID) defining a wireless network, a device address (Ded_Add) designating a target device, and sensing data. A wireless network may be identified based on the channel information (CH) and the wireless network ID information (PAN_ID), and a sensed device may be recognized based on the device address. The sensing signal includes the motion value and the illumination intensity value.

Also, referring to FIG. 41, the sensing signal analyzing unit 10220 analyzes the illumination intensity value and the motion value included in the sensing signal from the second ZigBee communications unit 10210 and provides the analysis results to the operation control unit 10230 (S220 in FIG. 44).

Accordingly, the operation control unit 10230 may perform a predetermined control according to the analysis results from the sensing signal analyzing unit 10220 (S230).

The sensing signal analyzing unit 10220 may analyze the sensing signal form the second ZigBee communications unit 10210 and detect a satisfied condition, among a plurality of conditions, based on the sensed motion and the sensed intensity of illumination. Here, the operation control unit 10230 may set a plurality of controls corresponding to the plurality of conditions set in advance by the sensing signal analyzing unit 10220, and perform a control corresponding to the condition detected by the sensing signal analyzing unit 10220.

For example, referring to FIG. 43, the sensing signal analyzing unit 10220 may detect a satisfied condition among the first, second, and third conditions (condition 1, condition 2, and condition 3) based on the sensed human motion and the sensed intensity of illumination by analyzing the sensing signal from the second ZigBee communications unit 10210.

In this case, the operation control unit 10230 may set first, second, and third controls (control 1, control 2, and control 3) corresponding to the first, second, and third conditions (condition 1, condition 2, and condition 3) set in advance by the sensing signal analyzing unit 10220, and perform a control corresponding to the condition detected by the sensing signal analyzing unit 10220.

For example, when the first condition (condition 1) corresponds to a case in which human motion is sensed at a front door and an intensity of illumination at the front door is not low (not dark), the first control may turn off all predetermined lamps. When the second condition (condition 2) corresponds to a case in which human motion is sensed at the front door and an intensity of illumination at the front door is low (dim), the second control may turn on some pre-set lamps (i.e., some lamps at the front door and some lamps in a living room). When the third condition (condition 3) corresponds to a case in which human motion is sensed at the door stop and an intensity of illumination at the front door is very low (very dark), the third control may turn on all the pre-set lamps.

Unlike the foregoing cases, besides the operation of turning lamps on or off, the first, second, and third controls may be variously applied according to pre-set operations. For example, the first, second, and third controls may be associated with operations of a lamp and an air-conditioner in summer or may be associated with operations of a lamp and heating in winter.

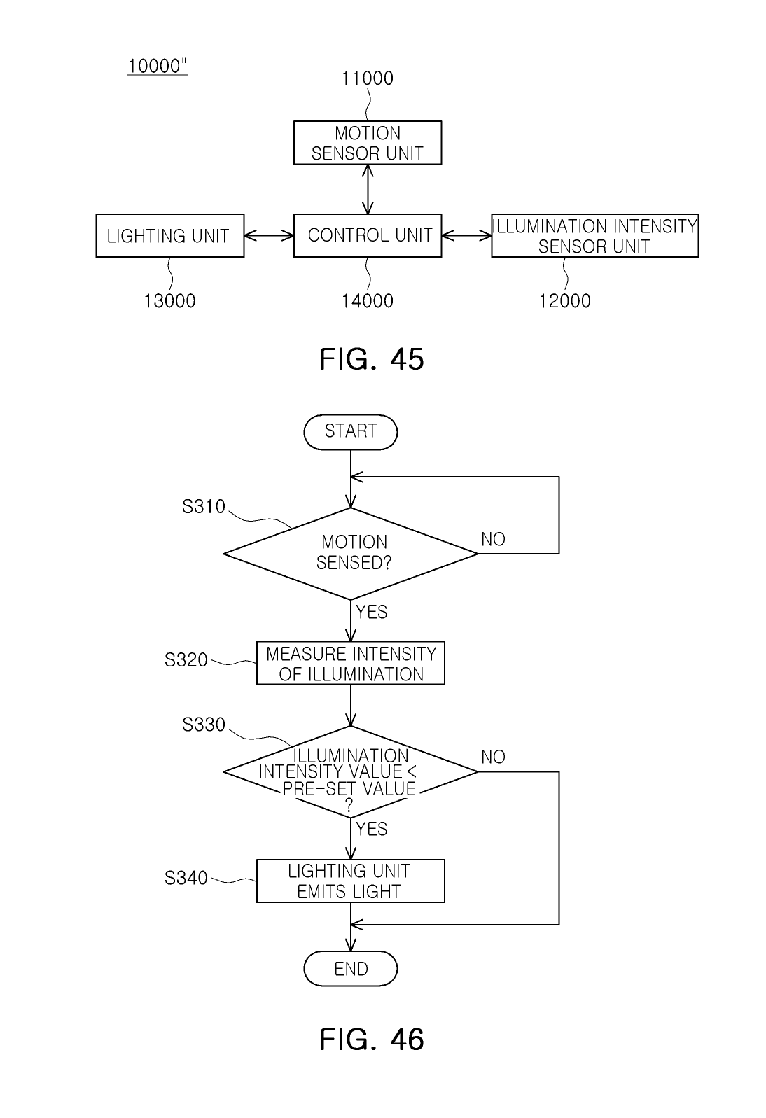

Another example of a lighting system using the foregoing lighting device will be described with reference to FIGS. 45 through 48.

FIG. 45 is a block diagram schematically illustrating constituent elements of a lighting system according to another exemplary embodiment. A lighting system 10000″ according to the present embodiment may include a motion sensor unit 11000, an illumination intensity sensor unit 12000, a lighting unit 13000, and a control unit 14000.

The motion sensor unit 11000 senses a motion of an object. For example, the lighting system may be attached to a movable object, such as, for example, a container or a vehicle, and the motion sensor unit 11000 senses motion of the object that moves. When the motion of the object to which the lighting system is attached is sensed, the motion sensor unit 11000 outputs a signal to the control unit 14000 and the lighting system is activated. The motion sensor unit 11000 may include an accelerometer, a geomagnetic sensor, or the like.

The illumination intensity sensor unit 12000, a type of optical sensor, measures an intensity of illumination of a surrounding environment. When the motion sensor unit 11000 senses a motion of the object to which the lighting system is attached, the illumination intensity sensor unit 12000 is activated according to a signal output by the control unit 14000. The lighting system illuminates during night work or in a dark environment to call a worker or an operator's attention to their surroundings, and allows a driver to secure visibility at night. Thus, even when a motion of an object to which the lighting system is attached is sensed, if an intensity of illumination higher than a predetermined level is secured (during the day), the lighting system is not required to illuminate. Also, even in the daytime, if it rains, the intensity of illumination may be fairly low, so there is a need to inform a worker or an operator about a movement of a container, and thus, the lighting unit is required to emit light. Thus, whether to turn on the lighting unit 13000 is determined according to an illumination intensity value measured by the illumination intensity sensor unit 12000.

The illumination intensity sensor unit 12000 measures an intensity of illumination of a surrounding environment and outputs the measurement value to the control unit 14000 as described hereinafter. Meanwhile, when the illumination intensity value is equal to or higher than a pre-set value, the lighting unit 13000 is not required to emit light, so the overall system is terminated.

When the illumination intensity value measured by the illumination intensity sensor unit 12000 is lower than the pre-set value, the lighting unit 13000 emits light. The worker or the operator may recognize the light emissions from the lighting unit 1300 to recognize a movement of a container, or the like. As the lighting unit 13000, the foregoing lighting device may be employed.

Also, the lighting unit 13000 may adjust intensity of light emissions thereof according to the illumination intensity value of the surrounding environment. When the illumination intensity value of the surrounding environment is low, the lighting unit 13000 may increase the intensity of light emissions thereof, and when the illumination intensity value of the surrounding environment is relatively high, the lighting unit 13000 may decrease the intensity of light emissions thereof, thus preventing power wastage.

The control unit 14000 controls the motion sensor unit 1100, the illumination intensity sensor unit 12000, and the lighting unit 13000 overall. When the motion sensor unit 11000 senses a motion of an object to which the lighting system is attached, and outputs a signal to the control unit 14000, the control unit 14000 outputs an operation signal to the illumination intensity sensor unit 12000. The control unit 14000 receives an illumination intensity value measured by the illumination intensity sensor unit 12000 and determines whether to turn on (operate) the lighting unit 13000.

FIG. 46 is a flow chart illustrating a method for controlling a lighting system. Hereinafter, a method for controlling a lighting system will be described with reference to FIG. 46.

First, a motion of an object to which the lighting system is attached is sensed and an operation signal is output (S310). For example, the motion sensor unit 11000 may sense a motion of a container or a vehicle in which the lighting system is installed, and when a motion of the container or the vehicle is sensed, the motion sensor unit 11000 outputs an operation signal. The operation signal may be a signal for activating overall power. Namely, when a motion of the container or the vehicle is sensed, the motion sensor unit 11000 outputs an operation signal to the control unit 14000.

Next, based on the operation signal, an intensity of illumination of a surrounding environment is measured and an illumination intensity value is output (S320). When the operation signal is applied to the control unit 14000, the control unit 14000 outputs a signal to the illumination intensity sensor unit 12000, and the illumination intensity sensor unit 12000 then measures an intensity of illumination of the surrounding environment. The illumination intensity sensor unit 12000 outputs the measured illumination intensity value of the surrounding environment to the control unit 14000. Thereafter, whether to turn on the lighting unit is determined according to the illumination intensity value and the lighting unit emits light according to the determination.

First, the illumination intensity value is compared with a pre-set value for a determination. When the illumination intensity value is input to the control unit 14000, the control unit 14000 compares the received illumination intensity value with a stored pre-set value and determines whether the former is lower than the latter. Here, the pre-set value is a value for determining whether to turn on the lighting device. For example, the pre-set value may be an illumination intensity value at which a worker or a driver may have difficulty in recognizing an object with the naked eye or may make a mistake in a situation, for example, a situation in which the sun starts to set.

When the illumination intensity value measured by the illumination intensity sensor unit 12000 is higher than the pre-set value, lighting of the lighting unit is not required, so the control unit 14000 shuts down the overall system.

Meanwhile, when the illumination intensity value measured by the illumination intensity sensor unit 12000 is higher than the pre-set value, lighting of the lighting unit is required, so the control unit 14000 outputs a signal to the lighting unit 13000 and the lighting unit 13000 emits light (S340).

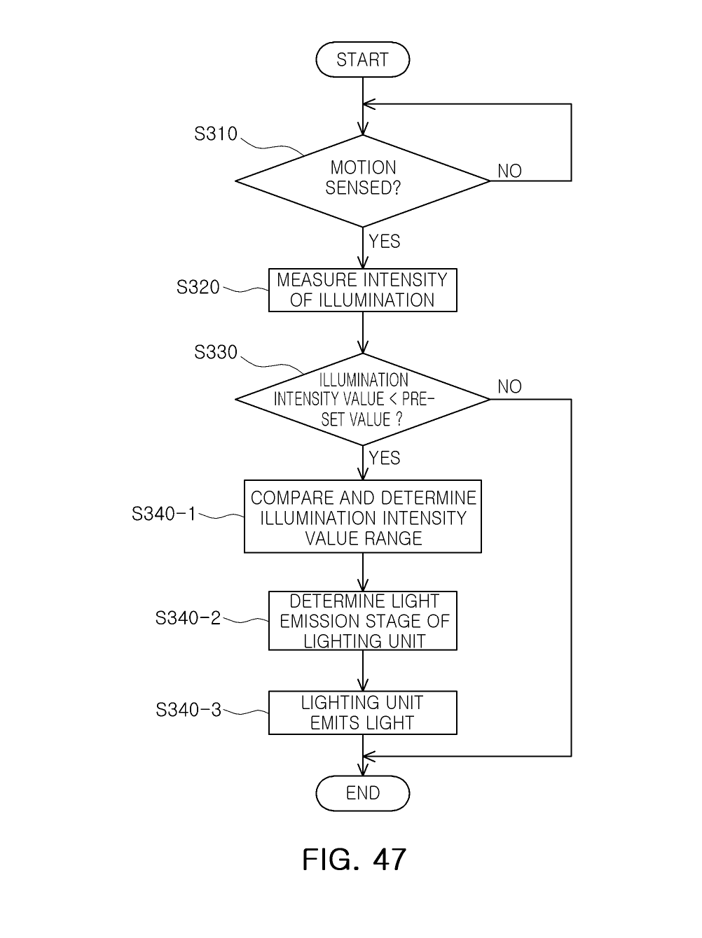

FIG. 47 is a flow chart illustrating a method for controlling a lighting system according to another exemplary embodiment. Hereinafter, a method for controlling a lighting system according to another exemplary embodiment will be described. However, the same procedure as that of the method for controlling a lighting system as described above with reference to FIG. 46 will be omitted.

As illustrated in FIG. 47, in the case of the method for controlling a lighting system according to the present embodiment, an intensity of light emissions of the lighting unit may be regulated according to an illumination intensity value of a surrounding environment.

As described above, the illumination intensity sensor unit 12000 outputs an illumination intensity value to the control unit 14000 (S320). When the illumination intensity value is lower than a pre-set value (S330), the control unit 14000 determines a range of the illumination intensity value (S340-1). The control unit 14000 has a range of subdivided illumination intensity value, based on which the control unit 14000 determines the range of the measured illumination intensity value.

Next, when the range of the illumination intensity value is determined, the control unit 14000 determines an intensity of light emissions of the lighting unit (S340-2), and accordingly, the lighting unit 13000 emits light (S340-3). The intensity of light emissions of the lighting unit may be divided according to the illumination intensity value, and here, the illumination intensity value varies according to weather, time, and surrounding environment, so the intensity of light emissions of the lighting unit may also be regulated. By regulating the intensity of light emissions according to the range of the illumination intensity value, power wastage can be prevented and a worker or an operator's attention may be drawn to their surroundings.

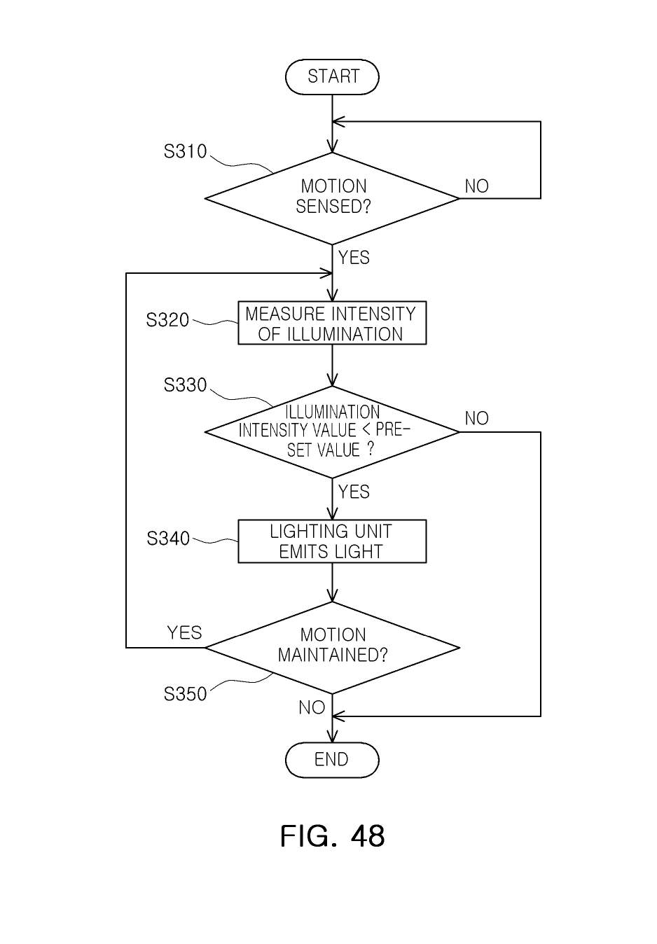

FIG. 48 is a flow chart illustrating a method for controlling a lighting system according to another exemplary embodiment. Hereinafter, a method for controlling a lighting system according to another exemplary embodiment will be described. However, the same procedure as that of the method for controlling a lighting system as described above with reference to FIGS. 46 and 47 will be omitted.

The method for controlling a lighting system according to the present embodiment further includes operation S350 of determining whether a motion of an object to which the lighting system is attached is maintained in a state in which the lighting unit 13000 emits light, and determining whether to maintain light emissions.

First, when the lighting unit 13000 starts to emit light, termination of the light emissions may be determined based on whether a container or a vehicle to which the lighting system is installed moves. Here, when a motion of the container is stopped, it may be determined that an operation thereof has terminated. In addition, when a vehicle temporarily stops at a crosswalk, light emissions of the lighting unit may be stopped to prevent interference with vision of oncoming drivers.

When the container or the vehicle moves again, the motion sensor unit 11000 operates and the lighting unit 14000 may start to emit light.

Whether to maintain light emissions may be determined based on whether a motion of an object to which the lighting system is attached is sensed by the motion sensor unit 11000. When a motion of the object continuously sensed by the motion sensor unit 11000, an intensity of illumination is measured again and whether to maintain light emissions is determined. Meanwhile, when a motion of the object is not sensed, the system is terminated.

The lighting apparatus using an LED as described above may be altered in terms of an optical design thereof according to a product type, a location, and a purpose. For example, in relation to the foregoing sensitivity illumination, a technique for controlling lighting by using a wireless (remote) control technique utilizing a portable device such as a smartphone, in addition to a technique of controlling a color, temperature, brightness, and a hue of illumination (or lighting) may be provided.

Also, in addition, a visible wireless communications technology aiming at achieving a unique purpose of an LED light source and a purpose as a communications unit by adding a communications function to LED lighting apparatuses and display devices may be available. This is because, an LED light source advantageously has a longer lifespan and excellent power efficiency, implements various colors, supports a high switching rate for digital communications, and is available for digital control, in comparison to existing light sources.

The visible light wireless communications technology is a wireless communications technology transferring information wirelessly by using light having a visible light wavelength band recognizable by humans' eyes. The visible light wireless communications technology is discriminated from a wired optical communications technology in the aspect that it uses light having a visible light wavelength band, and discriminated from a wired optical communications technology in the aspect that a communication environment is based on a wireless scheme.

Also, unlike RF wireless communications, the visible light wireless communications technology has excellent convenience and physical security properties in that it can be freely used without being regulated or permitted in the aspect of frequency usage, is differentiated in that a user can check a communication link with his/her eyes, and above all, the visible light wireless communications technology has features as a fusion technique (or converging technology) obtaining a unique purpose as a light source and a communications function.

As set forth above, according to exemplary embodiments, the lighting apparatus, capable of increasing the lifespan of a light source and improving light output by overcoming limited heat radiation efficiency according to natural convection to significantly increase heat radiation efficiency, can be provided.

In addition, the lighting apparatus having a size that falls within the ANSI standard, while having enhanced heat dissipation efficiency, can be provided.

Various advantages and effects of exemplary embodiments are not limited to the above descriptions, and will be more easily understood through the explanation of specific exemplary embodiments.

While the present invention has been shown and described in connection with the embodiments, it will be apparent to those skilled in the art that modifications and variations can be made without departing from the spirit and scope of the invention as defined by the appended claims.

What is claimed is:

1. A lighting apparatus comprising:
a base comprising a coupling rim and a supporting plate on an inner side of the coupling rim;
a housing configured to be coupled to the coupling rim such that the supporting plate is covered, the housing comprising a channel part that is configured to guide an introduction of air and an air introduction hole that is configured to introduce the air guided through the channel part into an inner space of the housing;
a cooling fan disposed on an upper surface of the supporting plate covered by the housing, wherein the cooling fan is configured to draw air introduced through the air introduction hole into the inner space of the housing, and discharge the in-drawn air outside through an air discharging hole in the base; and
a light source module mounted on a lower surface of the supporting plate,
wherein the channel part provides a region depressed in a stepped manner along an outer surface of the housing.

2. The lighting apparatus of claim 1,
wherein the air introduction hole comprises a ring shape along a circumference of the housing within the region depressed in the stepped manner of the channel part, and
wherein the channel part is upwardly extended along an outer side of the housing from a lower end of the housing to communicate with the air introduction hole.

3. The lighting apparatus of claim 1,
wherein the air introduction hole comprises a ring shape along a circumference of the housing, and
wherein the channel part comprises a first channel along the circumference of the housing in a position corresponding to the air introduction hole to communicate with the air introduction hole, and a second channel extended from the first channel to the lower end of the housing to be exposed to the outside.

4. The lighting apparatus of claim 1, wherein the channel part comprises a plurality of channels, and wherein at least one of the plurality of channels are recessed in the outer surface of the housing to communicate with the air introduction hole.

5. The lighting apparatus of claim 1, wherein the coupling rim comprises a groove having a shape and a position corresponding to the channel part such that the coupling rim is operable to connect with the channel part of the housing.

6. The lighting apparatus of claim 1, wherein the coupling rim comprises:
a flange part protruding outwardly from a lower end thereof,
wherein the flange part comprises a plurality of vents formed in a circumference of the coupling rim.

7. The lighting apparatus of claim 1, wherein the base comprises an air discharging hole between an outer circumferential surface of the supporting plate and an inner surface of the coupling rim to radially discharge the air introduced into the inner space of the housing.

8. The lighting apparatus of claim 1, wherein the base comprises an air discharging hole in a central portion of the supporting plate to discharge the air introduced into the inner space of the housing.

9. The lighting apparatus of claim 1, wherein the base comprises a plurality of heat radiation fins on the upper surface of the supporting plate facing the cooling fan.

10. A light source module comprising:
a base comprising an air discharging hole;
a housing comprising:
a channel part provided by a depressed region in a stepped manner along an outer surface of the housing; and
an air introduction hole configured to introduce air guided through the channel part into an inner space of the housing,
wherein the housing is configured to be disposed on an upper side of the base;
a cooling fan, configured to be disposed within the housing, and configured to draw air into the inner space of the housing, and discharge the in-drawn air outwardly through the air discharging hole; and
a light source module, configured to be disposed on a lower side of the base, and comprising at least one light emitting device and at least one lens disposed on the light emitting device.

11. The light source module of claim 10,
wherein the at least one lens comprises a first surface facing the at least one light emitting device and a second surface opposing the first surface,
wherein the at least one lens comprises:
a central incident surface configured such that light from the at least one light emitting device is incident on the central incident surface, and
a reflective portion configured to protrude toward the at least one light emitting device along the circumference of the central incident surface, wherein the reflective portion is symmetrical based on a central optical axis,
wherein the central incident surface and the reflective portion are provided in the first surface, and
wherein a refractive portion is provided in the second surface and is configured to protrude in a direction opposite the at least one light emitting device and is configured to be symmetrical based on the optical axis.

12. The light source module of claim 11, wherein the reflective portion comprises a first reflective portion and a second reflective portion having different rotational radii with respect to the optical axis and are concentric, wherein the first reflective portion and the second reflective portion have different sizes.

13. The light source module of claim 12,
wherein the first reflective portion comprises:
a first side incident surface to which light from the at least one light emitting device is made incident; and
a first reflective surface reflecting the incident light to the second surface,
wherein the second reflective portion comprises:
a second side incident surface to which light from the at least one light emitting device is made incident; and
a second reflective surface reflecting the incident light to the second surface.

14. The light source module of claim 11, wherein the refractive portion is configured to be disposed immediately above the at least one light emitting device, and wherein the refractive portion comprises:
a first refractive portion comprising a curved surface of which the optical axis is an apex; and
a second refractive portion forming a plurality of concentric circles with respect to the optical axis and comprising a convexo-concave structure formed along the circumference of the first refractive portion.

15. The light source module of claim 11, wherein the reflective portion is configured to be disposed outwardly of the refractive portion with regard to the optical axis such that the reflective portion surrounds the refractive portion.

16. A light source device comprising:
a base comprising a coupling rim disposed on an outer perimeter of an upper surface;
a housing wherein a lower edge of the housing is configured to connect to the coupling rim of the base;
a cooling fan configured to be disposed within the housing on the upper surface of the base;
a light source comprising at least one light emitting device configured to be disposed on a lower surface of the base; and
a backflow prevention part configured to be disposed within the housing on an upper surface of the cooling fan and extending from the upper surface of the cooling fan out to an inner surface of the housing below an introduction hole,
wherein the backflow prevention part is configured to prevent air drawn into an inner space of the housing through the cooling fan from flowing backward.

17. The light source device of claim 16, the housing further comprising:
a first channel formed on an outer surface of the housing, wherein the first channel extends perpendicularly and radially in relation to a central axis; and
a second channel formed on the outer surface of the housing, wherein the second channel extends from a lower edge of the first channel down to a lower edge of the housing,
wherein the introduction hole disposed in the first channel.

18. The light source device of claim 16, further comprising:
a cover, configured to be disposed on the light source, comprising at least one lens corresponding to the at least one light emitting device,
wherein the least one lens is configured refract and reflect light from the at least one light emitting device.

19. The light source device of claim 16, the base further comprising: at least one heat radiation fin disposed on the upper surface.
